(19) United States
(12) Patent Application Publication
(10) Pub. No.: US 2016/0063411 A1
(43) Pub. Date: Mar. 3, 2016

(54) SYSTEM AND METHOD FOR IDENTIFYING OPTIMAL ALLOCATIONS OF PRODUCTION RESOURCES TO MAXIMIZE OVERALL EXPECTED PROFIT

(71) Applicant: Zilliant Incorporated, Austin, TX (US)

(72) Inventors: Venkatesh Coimbatore Ravichandran, Austin, TX (US); Brian D. Hirt, Wauwatosa, WI (US); John Francis Brown, Sugar Land, TX (US)

(21) Appl. No.: 14/473,264

(22) Filed: Aug. 29, 2014

(51) Int. Cl. G06Q 10/06; G06Q 30/02

(52) U.S. Cl. CPC G06Q 10/06312; G06Q 30/0202

(57) ABSTRACT

Manufacturing companies deliver large quantities of products every day to multiple customers through different modes of transportation. The variety of products and the spread of manufacturing possibilities creates a complex cost management problem. The system used the mathematical framework of a directed graph to create a mathematical structure that captures dimensions within which the manufacturing facilities operate to deliver thousands of products to customers spread across various parts of the country. By assigning the most cost effective manufacturing facility to the most profitable and most probable demands, it ensures that the overall manufacturing network is optimized for maximum profit not just cost minimization. The solution design for the capacity optimization platform combines capacity and price to maximize profitability.

### BACKGROUND

Most B2B manufacturing companies face a massively complex environment typified by hundreds of products and customers, increasing competition, raw material cost volatility, constantly fluctuating futures contracts, logistical complexity and manufacturing limitations. Combined with other macroeconomic factors, manufacturers are in a constant struggle to maintain and improve profits.

Companies in the modern world have the ability to implement data tracking and storage systems, which record every detail of the manufacturing process continuously in real time. With the help of these systems, companies over the past few years have recorded and tracked their process information and have a plethora of manufacturing data including cost and production yields. Aiding these data tracking systems, data management systems have been used by these institutions to maintain the quality of data in collected datasets by flagging outliers and by adding background information. This generates a large data platform on which dynamic capacity allocation systems can be built to improve process efficiency in a more quantified manner.

Manufacturing companies deliver large quantities of products every day to multiple customers through different modes of transportation, including railway and trucks. The variety of products and the resources needed to manufacture and deliver those products create a complex resource utilization challenge for every operational and pricing decision the company needs to make in order to be profitable.

Companies often choose the path of least resistance when trying to take a more analytical approach to operational and pricing decisions. A common approach usually begins with data cleansing and analytics, which are report-centric. In other words, this is also referred to as hindsight analytics. While there may be some value in determining historical patterns, backward looking analytics provide little to no value when it comes to making better decisions for the future. The other common path is to build or purchase more sophisticated spreadsheet-based models in an attempt to make more optimal decisions.

As a result, employees have to apply subjective judgment and experience to make the output of the models practical.

Capacity allocation decisions and pricing decisions, the two primary profitability drivers, which are often handled separately by different teams, using spreadsheet-based models, intuition and experience.

Spreadsheet approaches simply aren't up to managing the complexity inherent in most manufacturers' businesses. By only focusing on minimizing cost when it comes to capacity decisions, manufacturers miss out on the opportunity to bring price into the equation to optimize overall profitability.

A limitation of this approach with strategic significance is that they can't connect pricing and capacity decisions to generate even higher profits. Only predictive price and profit optimization models can bridge this gap, while tackling the complexities.

When manufacturers receive an order, the typical question is: What is the cheapest way to fulfill this order? While that is a valid question, it's only half of the question they should be asking, which is: What is the cost effective way to meet the demand and what is the optimal price that can be fetched from the market?

A focus on price and cost at the same time is how companies can maximize profitability. To widen the gap between price and cost, capacity decisions need to be price-aware.

Assuming you have a reasonably accurate demand forecast, a predictive price optimization model can determine the price certain demand will generate from the market. The profit optimization model then enables the user to prioritize the assignment of a manufacturing facility to the demand with the highest probability of being realized, ensuring that the supply network operates at their highest profitability.

This profit optimization model also enables manufacturers to optimize several strategic and tactical decisions, not previously possible, including:

1) Which are the most cost effective manufacturing facilities for satisfying large customers?

2) Which manufacturing facilities need additional capacity?

3) How do changes in freight costs (due to volatile oil prices) affect overall profitability?

4) Which manufacturing facilities need to satisfy a certain seasonal demand?

5) Which manufacturing facilities have met maximum/minimum optimal capacity this quarter?

6) What are the preferred transportation modes in a certain region or customer?

7) What is the cascading result on the network when making a strategic move for a facility?

In addition to answering the above questions, the profit optimization system also highlights information to help managers plan for important decisions in the future.

First, the system is able to demonstrate the cost savings that may be realized by adding certain capability to a manufacturing facility allows for strategic facility design decisions to be made.

Second, the system can determine which manufacturing facility is best to act as back up to another facility, as it is sometimes cost effective to manufacture at one site and deliver it to the customer from another.

Third, the system determines alternate facilities in the event of a natural disaster or unforeseen downtime.

Fourth, the objective of the system is to maximize profitability and not just minimize cost. Therefore, the results are different from the traditional capacity optimization models that are focused solely on minimizing costs.

Fifth, because the system utilizes a price optimization engine, it generated price-aware capacity decisions that maximize profitability not just minimize costs.

Sixth, the price optimization engine includes a robust demand model engine that utilizes the probability that demand for a particular product will translate into an actual sale. This probability of demand ending in a sale is taken into account when the system allocates resources to the product.

Seventh, the system provides the ability to show not only an optimal solution for capacity allocation but also allows the user to see suboptimal contrasted with more optimal solutions.

Eighth, since the system in one embodiment may use a linear system model, the system can process voluminous data and complexity with a fast optimal solution, often in as little as ten minutes.

Ninth, the system is able to use the elasticity of demand of a product associated with a customer as input and assigns capacity resources such that expected profit is maximized. This is in contrast with other capacity optimization solutions that might make decisions about the allocation of capacity resources without taking into account the elasticity of demand or sensitivity of the customer which may result in a model assigning the lowest-cost manufacturing capacity to a customer demand which is highly sensitive and has a lower probability of converting to an actual sale. For example, if assigning two customer demands to two manufacturing facilities, where one customer is highly sensitive and likely not to convert to a sale, and where one manufacturing facility is less expensive than the other, where each manufacturing facility only had capacity for one of the demands, other capacity optimization solutions would assign the demands randomly between the two whereas the system using elastic of demand would be able to predict the sensitivity of the customer and make sure that the less sensitive demand most likely to convert to a sale will be fulfilled by the least expensive manufacturing facility.

Lastly, it highlights the cost-to-serve elements if a certain customer requires its product to be made in a certain facility which may not be the most cost effective option.

By thinking holistically about maximizing profits, manufacturers have a tremendous opportunity to not only make better day-to-day decisions, but transform how strategic decisions are made as well.

### SUMMARY

The system caters to this complex, multi-dimensional optimization challenge, ensuring that the company is operating at its maximum profitability in a business-to-business market environment. The system uses a mathematical framework that captures all the capacity and production constraints such as production capacity and specific product production limitations within which the manufacturing facilities operate to deliver large quantities of its products to customers located in various parts of the world. The first objective is to create a powerful, yet efficient computer-implemented optimization system that combines operational decisions and pricing decisions in a unique way. The second objective is to create a powerful computer-implemented data visualization system for the operations team to utilize these decisions in an effective manner.

The optimization system is designed to allocate customer demand forecasted for a pre-determined time period to a production facility. It also recommends a cost effective mode of transportation between the production facility and the customer, subject to feasibility constraints within the transportation system. When the manufacturing facilities make a specific product, they may have a few production modes to choose from. The optimization system is aware of the different cost structures for these production modes and recommends a cost-effective mode to go along with the other recommendations.

The data visualization system is designed to show the solutions to the user highlighting the decisions that show the highest benefit. It is comprised of an allocation solution change matrix that shows the most beneficial changes that were made to the current resource allocations if the current allocations are made available in the data. The system shows the breakdown of manufacturing and freight costs for the user, cost savings compared to the incumbent allocation solution, and the estimated profit given the recommendation from the optimization system. More particularly, embodiments include a data visualization system that enables the user to view the decision making process of the optimization system by highlighting all the options that were explored by the optimization. Each option is displayed along with the metrics that were key to making the allocation solution decision. This is supplemented by displaying utilization metrics of the manufacturing facility, associated machines and the transportation system.

One of the challenges in deciding optimal resource allocations is that it's dependent on a forecast of demand for the future. Given that this demand is an estimate and does not represent actual sales, companies can plan to minimize their production costs, but cannot ensure profitability if demand associated with certain allocations don't translate into actual sales. The system's ability to create a layer of communication between pricing and operational decision making systems enables the user to overcome the above mentioned inability and ensure profitability by making smart, price-aware resource allocation decisions.

The system makes the cost-effective resource allocation decision aware of the price a certain demand will generate from the market and the probability of that certain demand translating into an actual sale. The optimal price is a direct output of a price optimization module for estimating the sensitivity, or elasticity, of customer demand to changes in price in a business-to-business market environment such as the optimization model set forth in U.S. patent application Ser. No. 13/766,552, System and Method for Efficiently Estimating a Reliable Price Elasticity of Demand Using the Joint Demand Model, which is incorporated by reference in its entirety herein. This enables the manufacturer to prioritize the assignment of the most cost effective manufacturing facilities to the demands that will fetch the highest price and highest probability of resulting in an actual sale, thus ensuring that the manufacturing facilities will operate at their highest profitability. It can be safely assumed that a customer demand that is associated to a higher price is generally less sensitive and has a lower chance of defecting. Highly sensitive customers are usually associated with a lower price, as they would use competitors' quotes in the sales process. By assigning the most cost effective manufacturing facility to these most profitable and most probable system ensures that the overall manufacturing facility network is optimized for maximum profit.

The present method uses a mathematical framework which contains profitability as its core objective. Usually, other resource allocation optimization methods focus on improving utilization metrics like throughput or on decreasing costs for manufacturing while meeting the forecasted demand. Such methods usually have a disadvantage as it neglects the pricing side of the profitability equation. These methods might decrease cost but have a high probability of allocating cost-effective manufacturing facilities to demand that might not translate into an actual sale. This drawback can be detrimental to the manufacturer as cost effective facilities might be under-utilized due to lost demand. Other least-cost resource allocation solution systems also miss out on facilitating the user with alternative allocation solution options if the optimal allocation solution as chosen by the system fails to be feasible. Feasibility can be stated in the system as long as there is a realizable data stream to support that information. But in reality, there are scenarios where feasibility or infeasibility of an allocation solution is only known to the humans operating the production facilities at the tactical level. Embodiments include a data visualization system enables the user to see alternative options when the optimal solution is difficult to implement. The user also has the opportunity to express this infeasibility by modifying the capability data using the data interface. Cost savings can be demonstrated by adding certain capability to a manufacturing facility that allows for strategic facility design decisions to be made.

The optimization system can be configured to operate at a longer time-period and hence allows the strategic user to use the computer implemented optimization system for calculating the return on investment in the future. The optimization system is designed to incorporate allocation solution decisions over several time periods. This part of the system enhances the user's ability to make long-term strategic investments with quantifiable returns.

The system comprises a computer-implemented method for determining feasible solutions based on complex data inputs. The data inputs comprise of capability, capacity, cost and demand data. The feasibility generation algorithm built within the optimization system is implemented by computer-executable instructions executed by a computer processor. The system defines all possible resource allocation solutions from the capability data and then reduces this set of allocation solution options to a feasible set by combining capability with logistics and demand data to determine feasibility. This reduced set greatly enhances the computational efficiency of the system.

An embodiment of the system comprises of identifying a manufacturing facility to act as backup to another manufacturing facility when such an arrangement is logistically feasible and cost-effective. It is sometimes cost effective to manufacture in one manufacturing facility and deliver it to the customer from another. The preprocessing algorithm computes such feasible backup allocation solutions by combining the capability, cost and transportation data. Once feasible backup allocation solutions are generated into a set, another algorithm removes allocation solutions from the set based on its cost-effectiveness. This embodiment enables the system to determine all possible mechanisms to combine profitable and probable demands to the most cost effective options within the network of manufacturing facilities.

Another embodiment of the system comprises of loading the incumbent resource allocation solution plan and transition to the optimal resource allocation solution plan. This enables the system to illustrate the allocation solution changes that need to be done based on maximum benefit to transition from the existing state of resource utilization to the profit-optimal state of resource allocation solution. The user of the system can also view the Change Matrix within the data visualization system to ascertain the important re-allocations that need to be implemented. The system introduces the concept of incumbent allocation solution and challenger allocation solutions. The system is able to highlight challenger allocation solutions if the optimal resource allocation solutions are infeasible and not stated in the data. The computer-implemented instructions can be re-processed by the processor to incorporate this additional data and find profit-optimal allocation solutions given this feedback.

The data visualization system comprises of a display system that shows a graphic with detailed breakdowns of the cost and price associated with a demand and the recommended allocation solution. This will highlight the primary component that makes the allocation solution the optimal one. Such visibility enables the user to validate the data and implement the resource allocation solution with confidence.

The system uses an iterative methodology, which enables the users with the ability to remove and add manufacturing facilities considered by the optimization model. This will allow the system to re-optimize the network of manufacturing facilities when there is a significant downtime at some facilities within the network. This can be caused due to natural calamities or merger/acquisitions with other facilities in the market.

From a performance perspective, the computer-implemented system produces the optimal resource allocation solution in a very short time and is achieved by smart preprocessing techniques implemented within the optimization system. The algorithm within the optimization system reduces the search space for an optimal solution by a significant amount based on certain set of known business rules. It also uses cost and price information to deduce cost-effective feasible allocation solution options for the optimization system to consider.

### BRIEF DESCRIPTION OF DRAWINGS

These and other features, aspects and advantages of the system will become better understood with regards to the following description, appended claims and accompanying drawings wherein:

FIG. 1 depicts a computer system and the network suitable for implementing the system for generating profit-optimal resource allocation solutions.

FIG. 2 is functional diagram illustrating the computer implemented system and the method for generating profit-optimal resource allocation solutions.

FIG. 3 is a diagram representing the supply and demand data that the computer implemented system may use.

FIG. 4 depicts a flow diagram illustrating the data preparation algorithm.

FIG. 5 depicts a functional flow diagram of the data-preprocessing algorithm that determines a feasible set of allocation solutions to be considered for optimization.

FIG. 6 is a flowchart depicting the data-preprocessing algorithm that determines a feasible set of allocation solutions to be considered for optimization.

FIG. 7 is a functional flow diagram illustrating the feasible solution generator.

FIG. 8 is a flow diagram illustrating the algorithm that generates the backup facility allocation solutions that are feasible given the data.

FIG. 9 is a flowchart illustrating the computation of profitability of an allocation solution.

FIG. 10 is a direction graph depicting the different types allocations that are considered for profitability.

FIG. 11 is a representation of the mathematical framework that enables the expression of the resource allocation solution optimization and its associated constraints.

FIG. 12 is a functional block representation of the optimization process that determines the profit-optimal resource allocation solutions.

FIG. 13 depicts the flow diagram illustrating the output data preparation method as the data is transferred from the optimization system to the data visualization system.

FIG. 14 depicts the workflow of the user interacting with the data user interface.

FIG. 15 illustrates the various components of the data user interface

FIG. 16 depicts the flow diagram illustrating the workflow of the data visualization system.

FIG. 17 depicts the allocation solution change matrix which illustrates the allocation solution change between the initial state of incumbent allocation solutions and the optimal set of recommended allocation solutions.

FIG. 18 depicts the visualization system showing the largest opportunities identified by the optimization system.

FIG. 19 depicts the graphic shown by the visualization system showing the incumbent allocation solution and challenger allocation solutions that were considered by the optimization system.

FIG. 20 depicts the graphic shown by the visualization system showing the cost breakdown of the allocation solution considered enabling the user to view the true advantage of using that allocation solution as compared to the incumbent allocation solution.

FIG. 21 depicts a flow diagram of the method for identifying profit-optimal resource allocation solutions.

FIG. 22 is a flow diagram illustrating the workflow of the user interacting with the system.

FIG. 23 depicts the graphic shown by the visualization system showing the resource utilization metrics inclusive of capacity of each facility and machine within the scope of the optimization.

FIG. 24 depicts the graphic shown by the visualization system showing the limits on the practical constraints implemented by the system to make the recommended allocation solutions usable.

FIG. 25 depicts a computer system and network suitable for implementing the system for determining price optimization as part of the price optimization engine.

FIG. 26 is a functional block diagram illustrating a computer implemented system and method for determining pricing recommendations 2600 as part of the price optimization engine.

FIG. 27 is a functional block diagram illustrating one embodiment of a system and method 2700 for constructing a joint demand model lookup table used to efficiently estimate the parameters of the joint demand model of the price optimization engine.

FIG. 28 is a functional block diagram illustrating the elasticity estimator which relies upon a pre-generated joint demand model parameter lookup table of the price optimization engine.

FIG. 29 is a flow diagram representing the JDM parameter estimator of the price optimization engine.

FIG. 30 is a flow diagram of an exemplary embodiment of the method for determining optimized product price recommendations 3000 as part of the price optimization engine.

### DETAILED DESCRIPTION OF SYSTEM

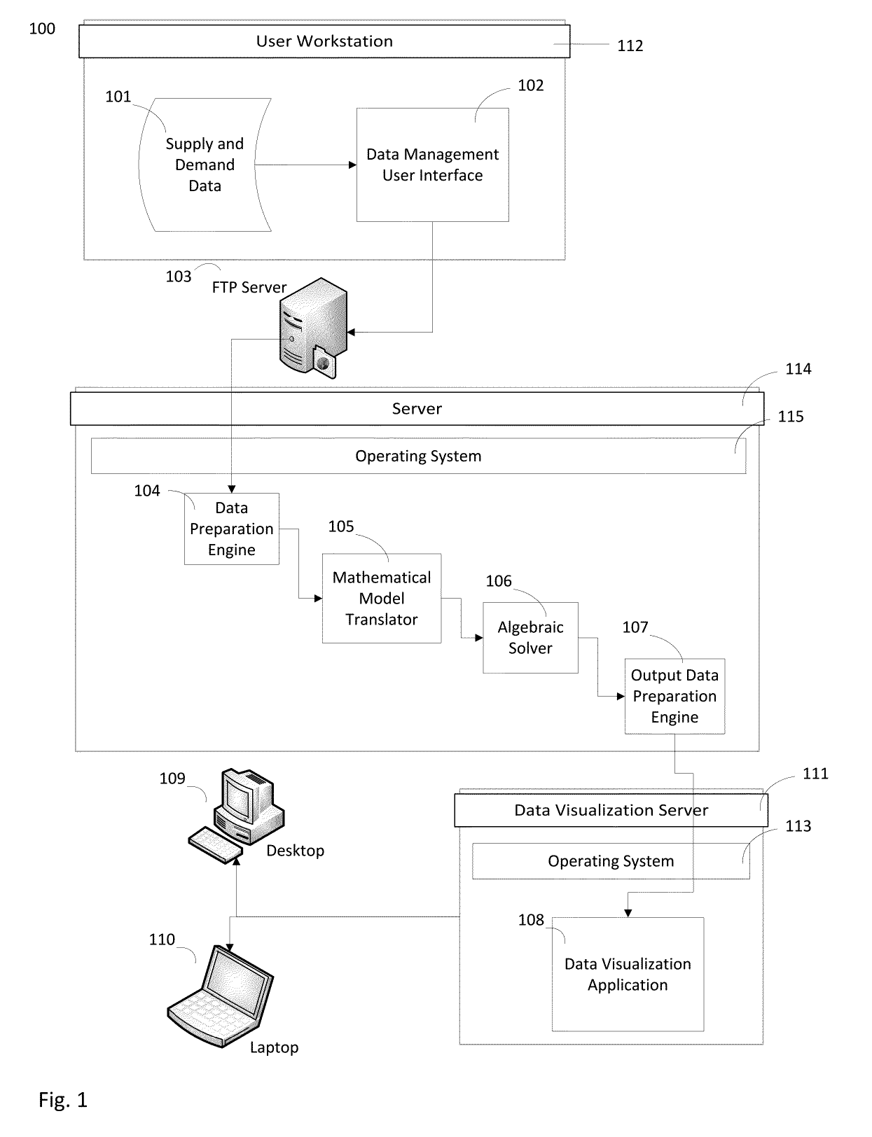

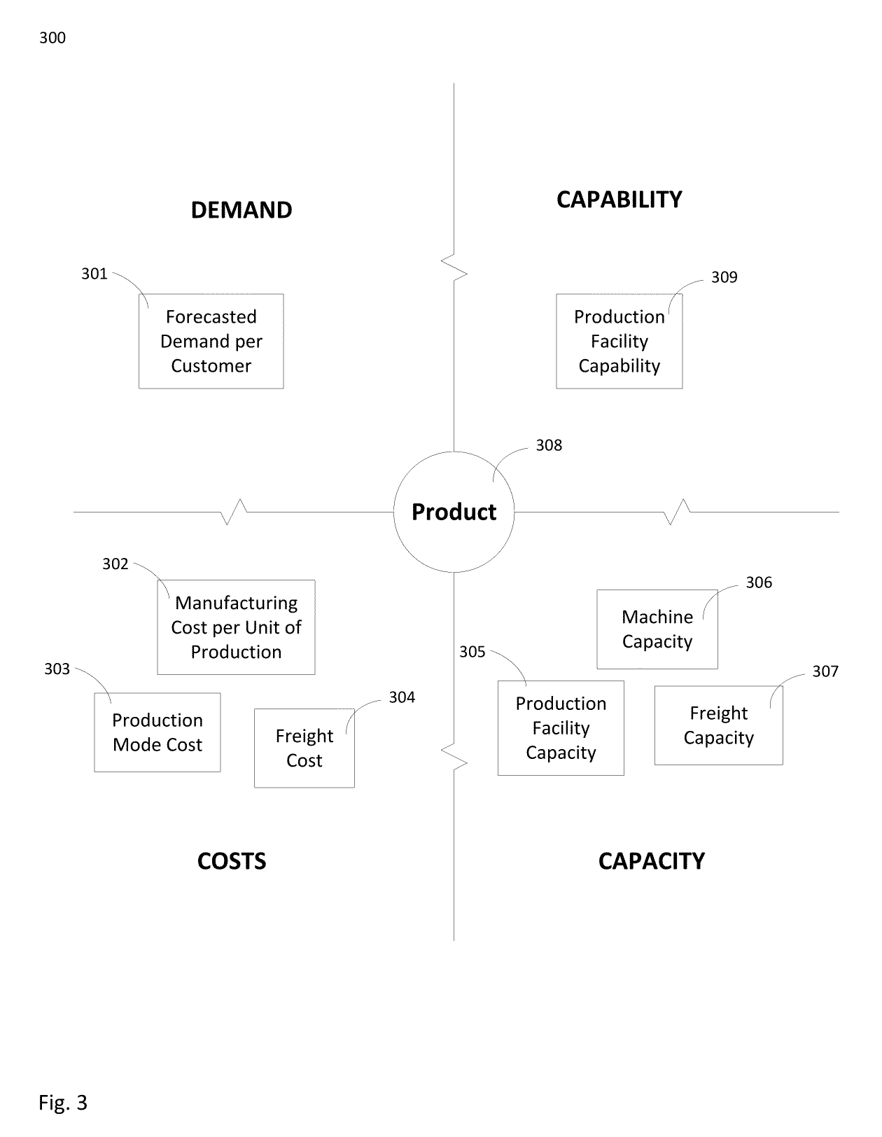

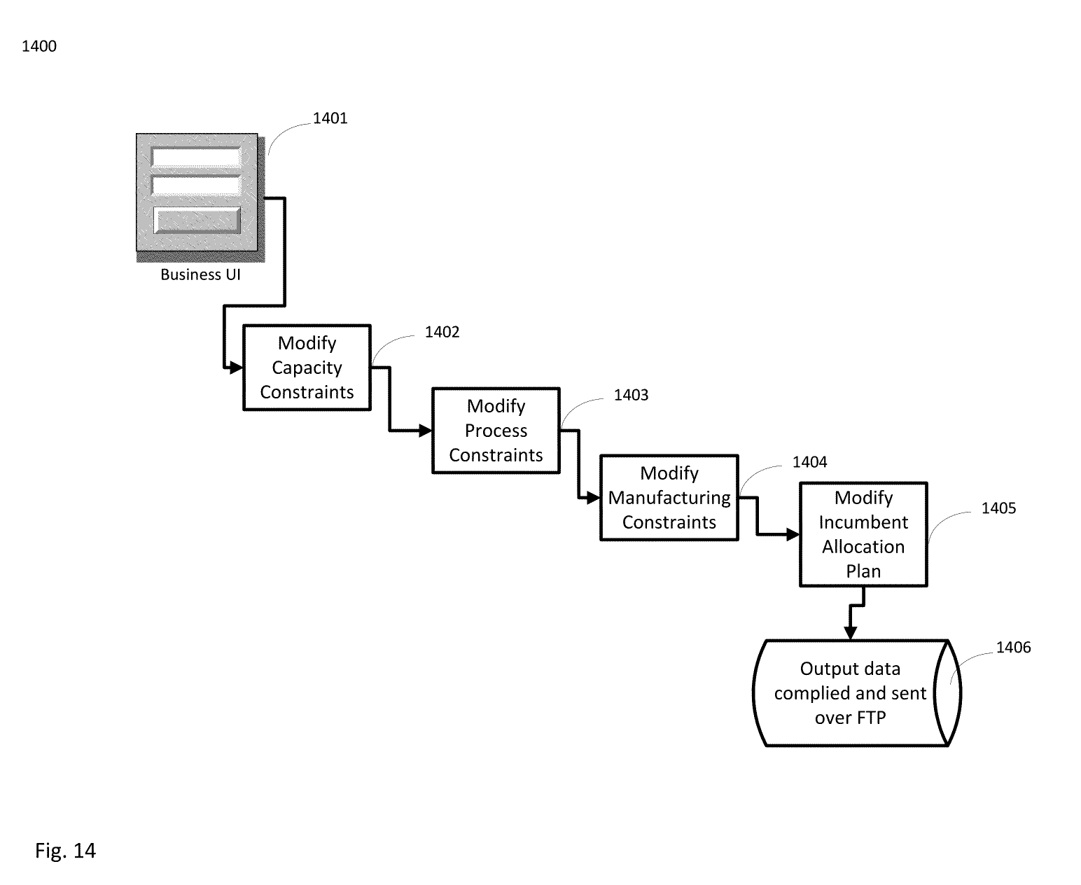

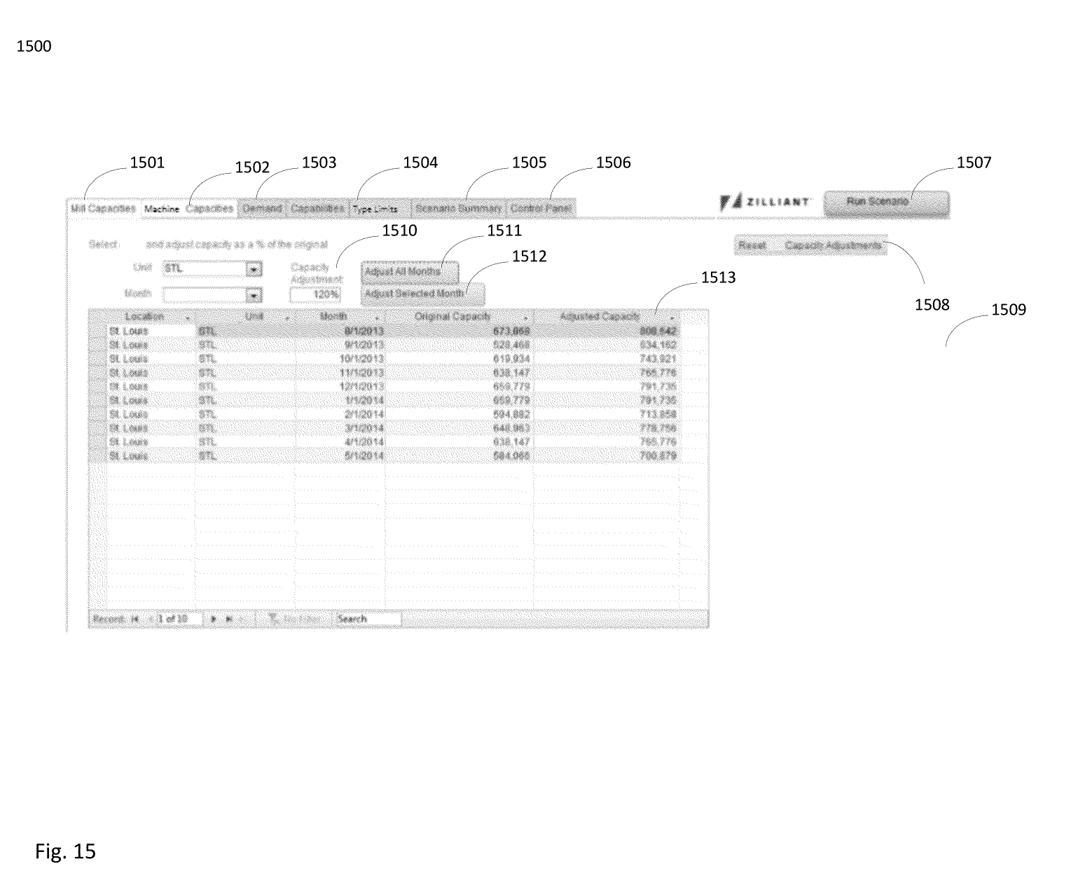

FIG. 1 illustrates the computer system of the system 100 comprising a user workstation 112, a server 114, running an operating system 115 including but not limited to MS Windows, Linux, Unix and the like hosting the optimization system and a data visualization server 111 running an operating system 113 including but not limited to MS Windows, Linux, Unix and the like hosting the data visualization system. This figure represents the various components of this system and flow of supply and demand data 101 from a source user workstation 112 to graphics displayed through the data visualization server 111 to the desktop 109 or the laptop 110. The supply and demand data (explained in more depth in FIG. 3) flow into the data management user interface 102 that is used by the user to modify the data (explained in detail in FIGS. 14 and 15). Once the data is modified the data management user interface 102 packages the data and sends it over to an FTP server 103. The FTP server 103 constantly looks for incoming files in the FTP server 103 and transfers them over to the data preparation engine 104. The data preparation engine prepares the data and passes it in a format that is used by a mathematical model translator 105. The mathematical model translator 105 translates the data into a mathematical representation of the manufacturing system and passes it on to the algebraic solver 106 that is used to optimize and find profit-optimal resource allocation solutions. These allocation solutions are passed on to the output data preparation engine 107. The data is packaged by the output data preparation engine 107 and sent to the data visualization server 111 and data visualization application 108 so as to allow the display of the allocation solutions visually to the user through their desktop 109 or through their laptop 110.

As used herein a server is a system (computer software and suitable computer hardware having a software operating system) that responds to requests across a computer network to provide, or help to provide, a network service. Servers can be run on a dedicated computer, which is also often referred to as “the server”, but many networked computers are capable of hosting servers. In many cases, a computer can provide several services and have several servers running. Servers are comprised of at least a computer processor and memory. Servers operate within a client-server architecture; servers may be computer programs running to serve the requests of other programs, the clients. Thus, the server performs some task on behalf of clients. The clients typically connect to the server through the network but may run on the same computer. In the context of Internet Protocol (IP) networking, a server is a program that operates as a socket listener. Servers often provide essential services across a network, either to private users inside a large organization or to public users via the Internet. Typical computing servers are database server, file server, mail server, print server, web server, gaming server, application server, or some other kind of server. Numerous systems use this client and server networking model including Web sites and email services. An alternative model, peer-to-peer networking enables all computers to act as either a server or client as needed. The term server is used quite broadly in information technology. Despite the many server-branded products available (such as server versions of hardware, software or operating systems), in theory any computerized process that shares a resource to one or more client processes is a server. To illustrate this, take the common example of file sharing. While the existence of files on a machine does not classify it as a server, the mechanism which shares these files to clients by the operating system is the server. Similarly, consider a web server application (such as the multiplatform “Apache HTTP Server”). This web server software can be run on any capable computer. For example, while a laptop or personal computer is not typically known as a server, they can in these situations fulfill the role of one, and hence be labeled as one. It is, in this case, the machine's role that places it in the category of server. In the hardware sense, the word server typically designates computer models intended for hosting software applications under the heavy demand of a network environment. In this client-server configuration one or more machines, either a computer or a computer appliance, share information with each other with one acting as a host for the others.

The server 114 and the data visualization server 111 may be physical or virtual computer machines and may be co-located within the same physical server. The networked computers may be physical server computers or virtual machines. Virtual machines are software simulations of the hardware components of a physical machine (physical computer server). Although a physical machine host is required for implementation of one or more virtual machines, virtualization permits consolidation of computing resources otherwise distributed across multiple physical machines to fewer or even a single host physical machine. The servers may use software applications for allowing virtualization of servers, storage and networks, allowing multiple software applications to run in virtual machines on the same physical servers. Alternatively, the networked computers may be physical workstations such as personal computers, or a mixture of servers and workstations. The servers may be, for example, SQL servers, Web servers, Microsoft Exchange servers, Linux servers, Lotus Notes servers (or any other application server), file servers, print servers, or any type of server that requires recovery should a failure occur. Most preferably, each protected server computer runs a network operating system such as Windows or Linux or the like. The computer network connecting the servers and the user may be an Internet network or a local area network (LAN). The network may be implemented as an Ethernet, a token ring, other local area net protocol or any other network technology, such network technology being known to those skilled in the art. The network may be a simple topography, or a composite network including such bridges, routers and other network devices as may be required.

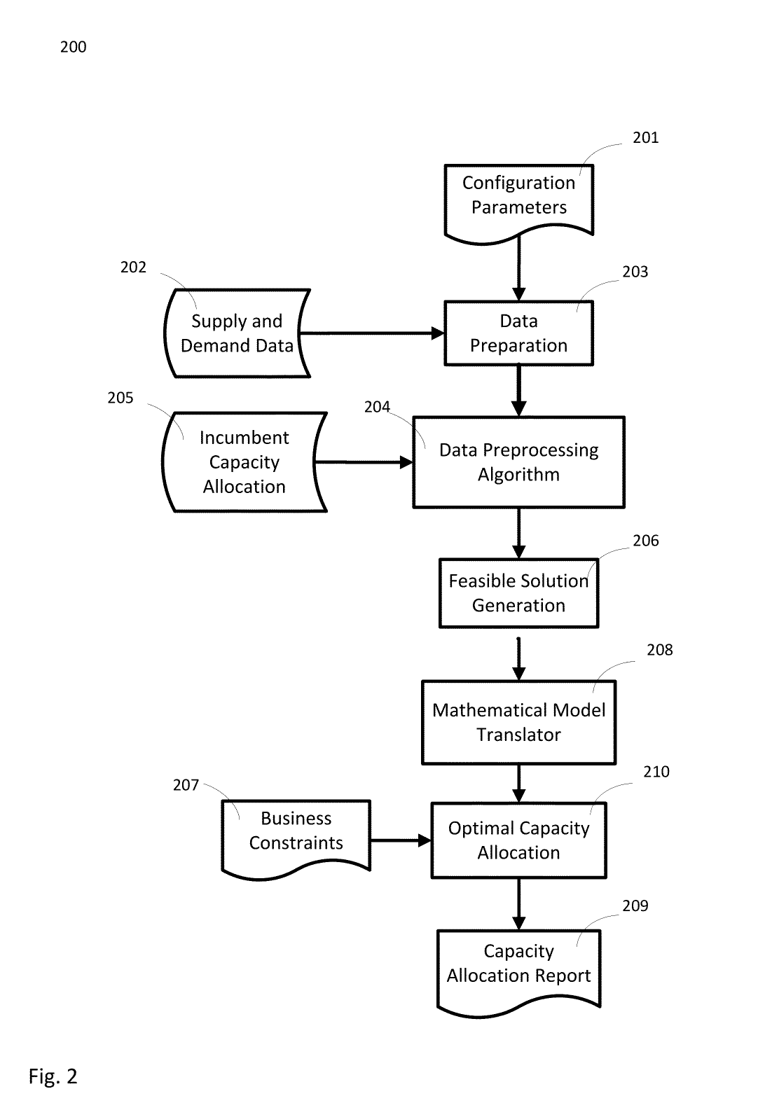

FIG. 2 represents a functional flow diagram of the method to find profit-optimal resource allocation solutions 200 with each diagram block representing a module within the system. Configuration parameters 201 such as production capacity and capability data are supplied through the data management user interface 102 (in FIG. 1). The data preparation step 203 combines the configuration parameters with the supply and the demand data (described in detail in FIG. 3) that is then together processed by a computer-implemented method to transform it into datasets that are read by the data-preprocessing algorithm 204. The data preprocessing algorithm 204 combines the incoming dataset with the incumbent capacity allocation solutions dataset 205 which is the set of existing allocations planned to satisfy the demand. The feasible solution generation module 206 receives the dataset from data preprocessing algorithm 204 and computes feasible sets of allocations for each product under consideration for all time periods configured within the system. The information is then passed on to the mathematical model translator 208 that translates the feasible set into a mathematical framework which is a representation of each allocation as a continuous variable representing the quantity of products being allocated to each production facility. This framework also consists of business constraints 207 that are added and used by the optimal capacity allocation solution module 210 to generate profit-optimal resource allocation solutions. Business constraints may include capacity, production and shipping constraints. The allocation solutions are viewed by the user through a capacity allocation solution report 209 for validation and usage.

FIG. 3 illustrates all the components of the supply and demand data (FIG. 1, 101) referred in the earlier figures. The supply and demand data for each product consists of four major components: demand data, capability data, cost data and capacity data for each product 308. The demand data consists of a forecasted demand 301 per customer for each time period under consideration. The capability data consists of the production facility capabilities 309 per product. The capacity data consists of three components listed as follows: machine capacity 306, production facility capacity 305 and freight capacity 307. The cost data is represented by the manufacturing cost per unit of production 302, production mode cost 303 which may vary depending on the type of production process employed and the freight cost 304 for each product 308. The different types of production processes refers to multiple recipes that the manufacturing company might employ on how to make a product or a set of products. This grouping of product data allows for successful allocation solution recommendations for each product.

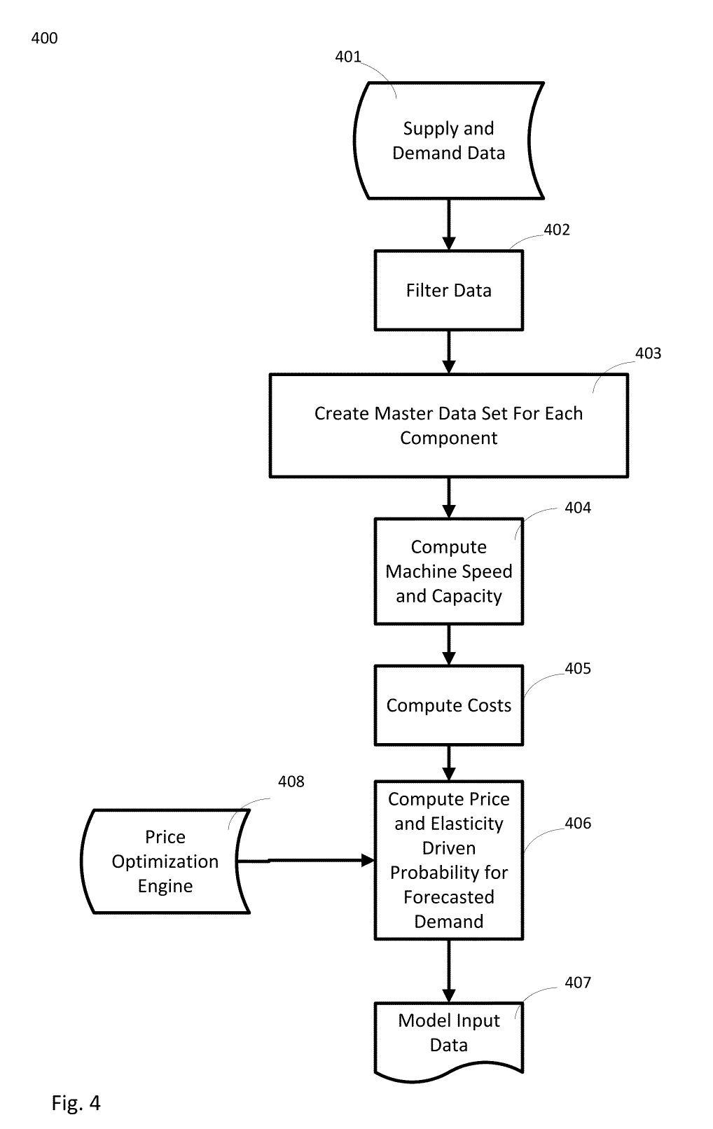

FIG. 4 is an embodiment of the data preparation engine 104 that loads, combines and translates multiple data sources for the supply and demand data (FIG. 1, 101) into a format that serve as an input to the mathematical model translator 105. The supply and demand data 401 (FIG. 1, 101) is filtered for outliers and known bad data inputs in the filter data module 402. The next step is to convert the filtered data into master dataset representation 403 for each component such as customer, forecasted demand per customer, production facilities and their capabilities, production mode cost, manufacturing cost, machine capacity, freight capacity and freight costs, and the like. Data from this master dataset 403 is utilized to compute the processing speed or the capacity 404 of each internal or shared resources including but not limited to machines within the production facilities. Another computation is performed to combine all different types of costs such as manufacturing cost, production mode cost and freight cost to determine the total cost of each allocation solution. 405. The next module computes the price and probability of each demand 406 given the price information from the price optimization engine module 408. Most of this information is then combined into a dataset called the model input data 407.

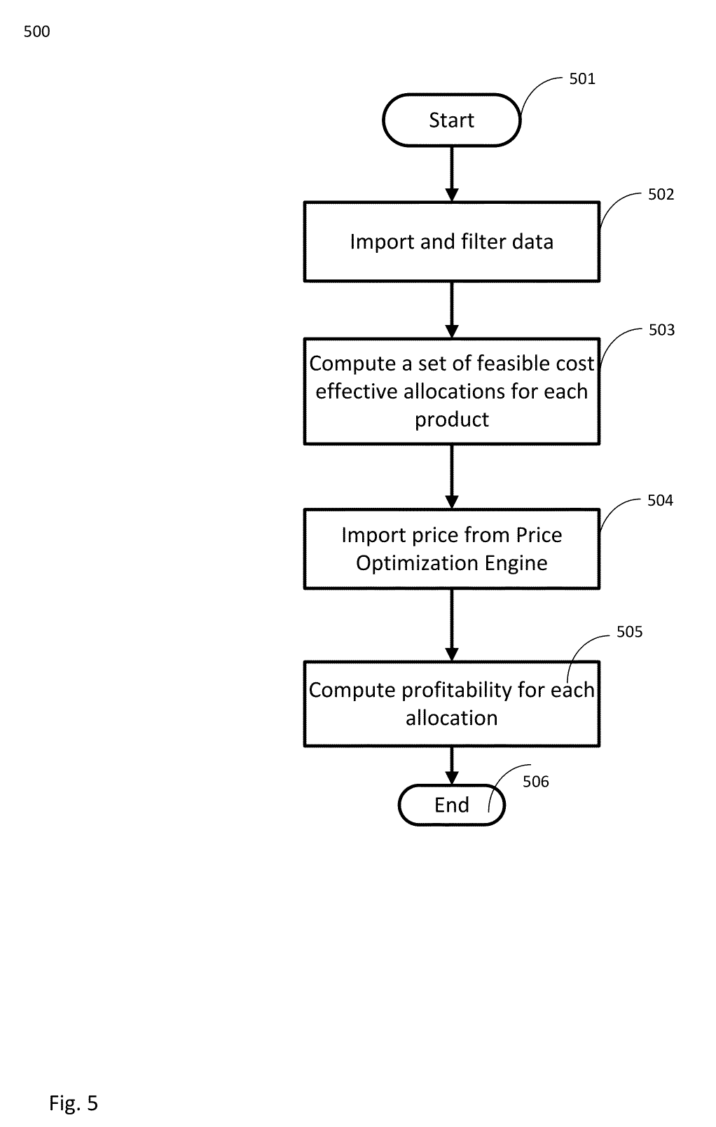

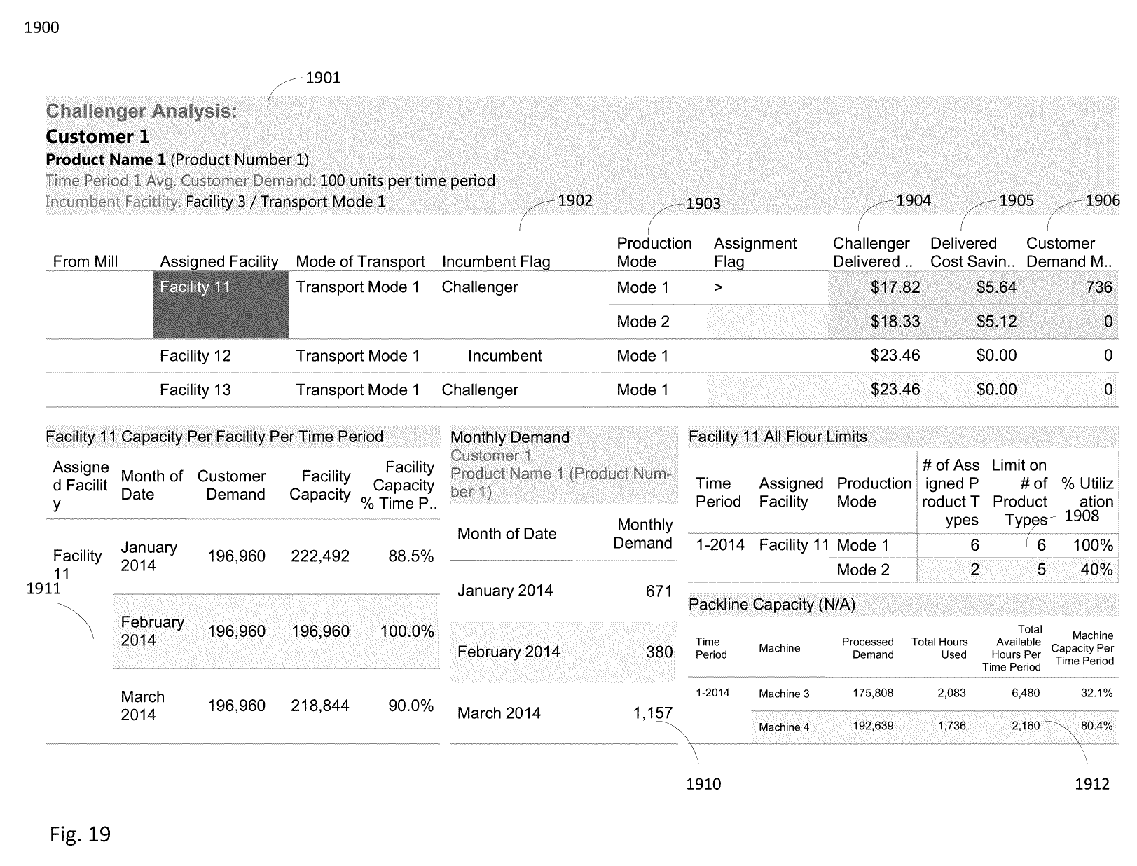

FIG. 5 is an embodiment of the system that illustrates the functional workflow of the data processing algorithm 500 (FIG. 2, 204) of the data preparation engine (FIG. 1, 104). The core steps of the algorithm upon starting 501 are to import and filter data 502 based on pre-defined rules to ensure that only quality data are used in the subsequent processing steps. Quality data means data that does not contain any inconsistent or duplicate information that would prevent the model process from running as intended The data preprocessing algorithm 500 of the data preparation engine then computes a set of cost-effective feasible allocation solution options that are used as part of the optimization process for each product 503. The output of step 503 is combined with the price information 504 from the price optimization engine module. Given the set of feasible and cost-effective allocation solutions, an example of which is shown in FIG. 19, the specific cost of each possible production allocation solution and price that can be achieved in satisfying the specific demand, the algorithm then computes the estimated profitability 505 of each allocation solution. This process marks the end of the data pre-processing algorithm 506.

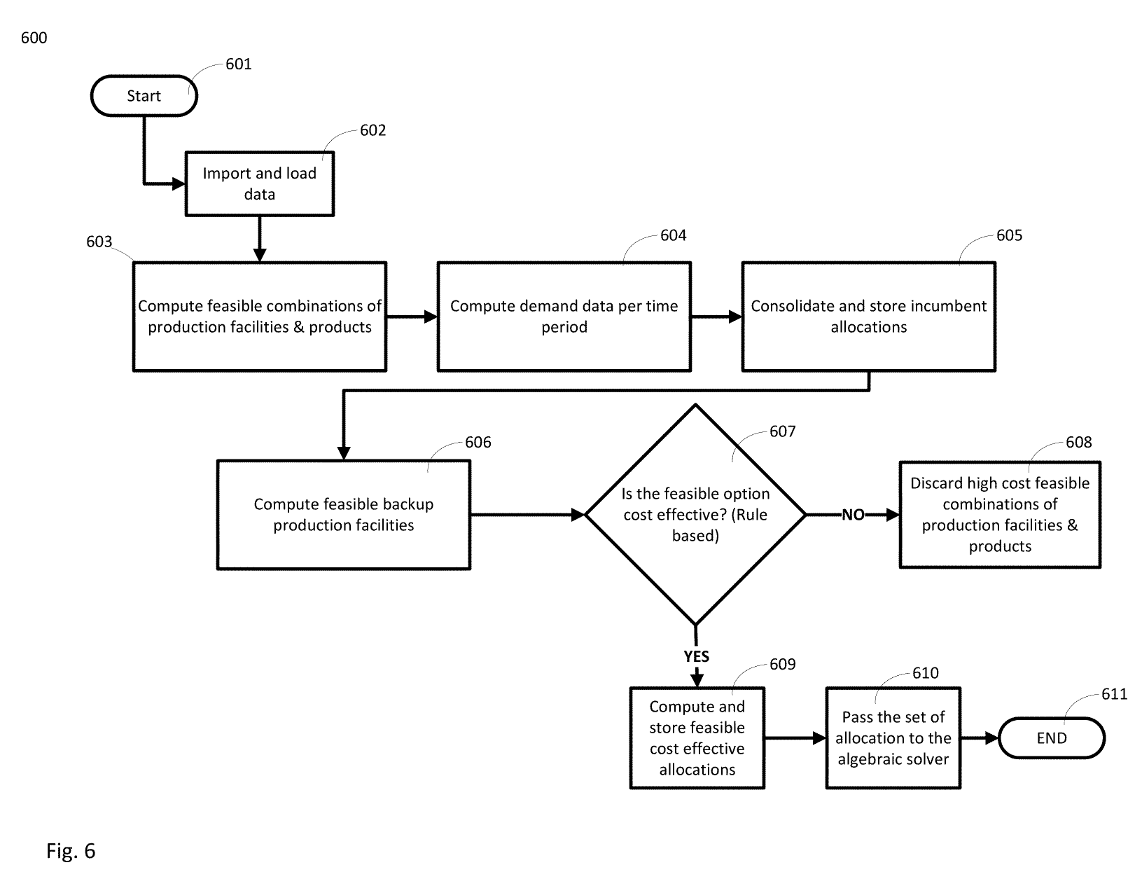

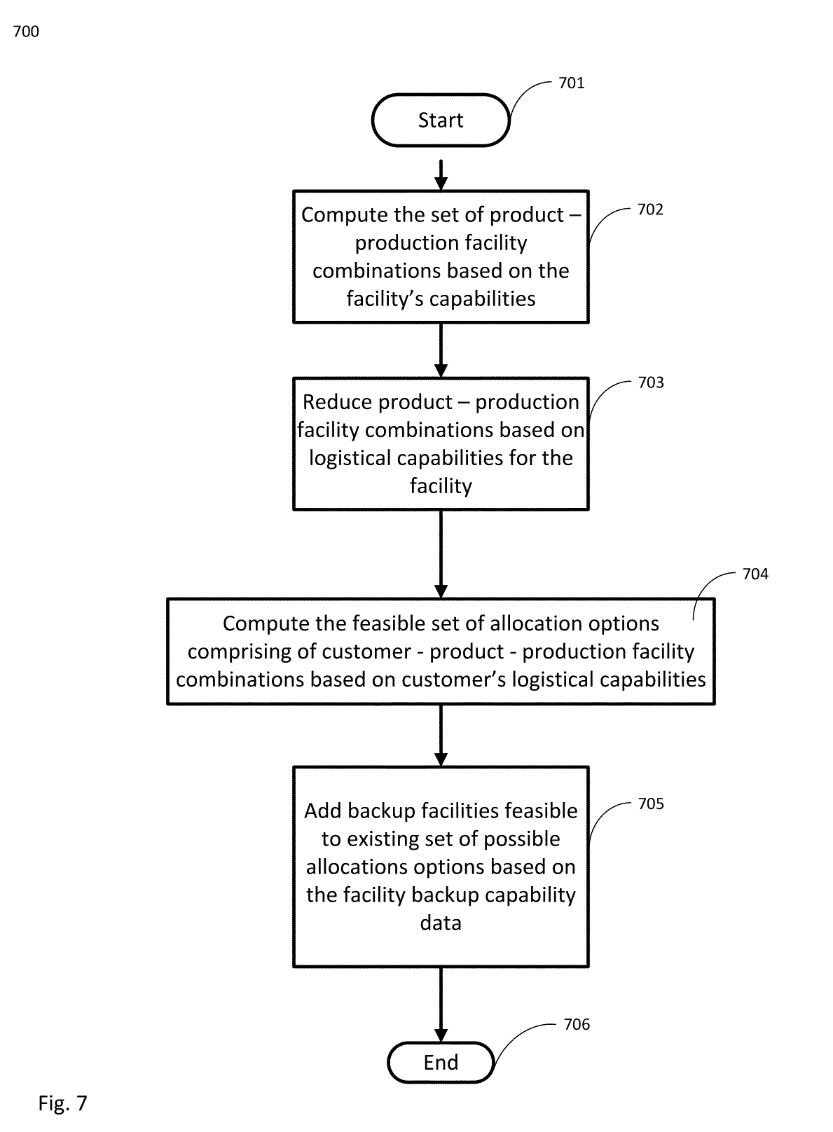

FIG. 6 shows an illustrated flowchart detailing the logical process flow 600 of the computation of the data-preprocessing algorithm 500 (FIG. 2, 204) of the data preparation engine (FIG. 1, 104) functionally shown in FIG. 5. The process starts 601 with importing and filtering manufacturing facility supply, customer demand and production cost data 602, such as that shown in FIG. 3, by removing data points that match the predetermined patterns of bad data. Next computing 6 of feasible combinations of production facilities and products that they can manufacture 603 based on the capability data components shown in FIG. 3. Step 603 is shown in FIG. 7 and discussed in more detail below in the discussion of FIG. 7. In step 604, is represented the computation of forecasted demand data per customer (FIG. 3, 301) per time period wherein the demand data-points are aggregated at a customer-product and time period level of granularity. In step 605 is represented the process of consolidating and storing the incumbent allocation solutions which are the planned allocation solutions for the demand data prior to any processing by the model. The next step 606 is to compute feasible backup production facilities 606 that could serve as additional production facilities that are located on transportation routes that have a cost effective transportation option. The algorithm then uses a rule, including but not limited to “comparing a backup production facility to a manufacturing facility that can manufacture and transport the product to the customer's geographic area”, that compares similar production and transportation cost allocation solution options and determines the production and transportation cost allocation solution option with lower cost 607. If an option is not cost effective (meaning the cost allocation solution for production and transportation is higher in comparison to another available option, then it's discarded 608. If an option is cost effective (meaning the cost of allocation solution for production and transportation is lower in comparison to other available option), then it's included in the set of cost effective feasible allocation solution options to be saved and stored represented by 609. These set of cost effective feasible allocation solution options 610 are passed on to the algebraic solver which is used to derive the optimal allocation solution. This marks the end 611 of the logical flow of the data pre-processing algorithm of the data preparation engine (FIG. 1, 104).

FIG. 7 is an embodiment of the system that represents the logical flow 700 of the function of determining the feasible solutions (FIG. 2, 206) of the data preparation engine (FIG. 1, 104). It computes the set of production facility and product combinations 702 based on the production facility's capabilities. The logistical information such as the facility's location is used to determine logistic feasibility for transporting the product from the facility. Given this information, it trims the set of combinations 703 by removing the production facility—product combinations that are not logistically feasible. The customer's logistical feasibility (where the customer is located and needs product shipped) is used to determine which routes are available for transportation. This further refines the set into a primary solution which comprises a set of allocation solutions that are defined by a combination of product, production facility, transportation mechanism and the time period 704. Further, the feasible solution generation method computes feasible backup production facilities and transportation mechanisms 705 that can be serve as a backup solution to supplement the capacity of the primary solution production facility.

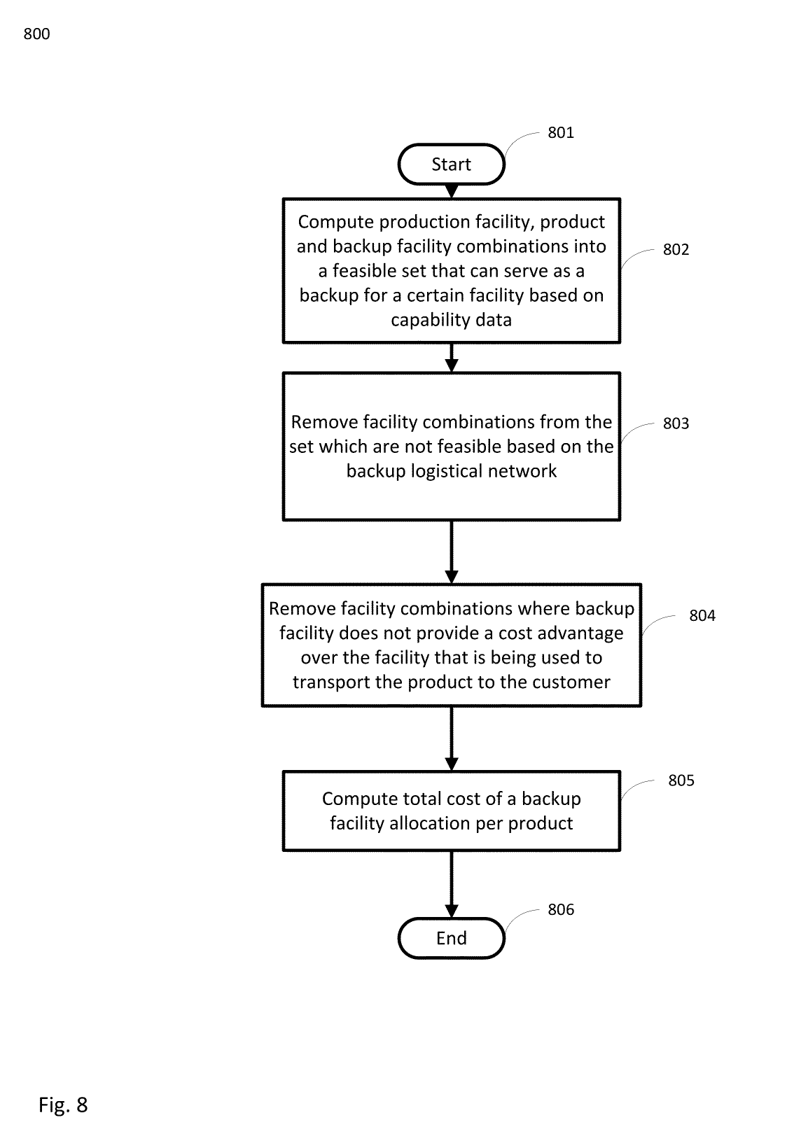

FIG. 8 further illustrates the process of determining backup production and transportation facilities 800 to a feasible allocation definition as set forth in FIG. 7, 705. The method starts 801 by computing the production facility that serves as a backup for a certain product based on the capability data 802 associated with that production facility (FIG. 3, 309). This is further enhanced by removing facility-product combinations that are not feasible based on the backup transportation network 803, including but not limited to intra-facility transportation systems. More combinations are removed when a backup facility is more expensive than the primary facility 804. Each backup facility, production facility and product combination can now be collected in one set and the method computes the cost of every solution in that set 805 and processing ends 806.

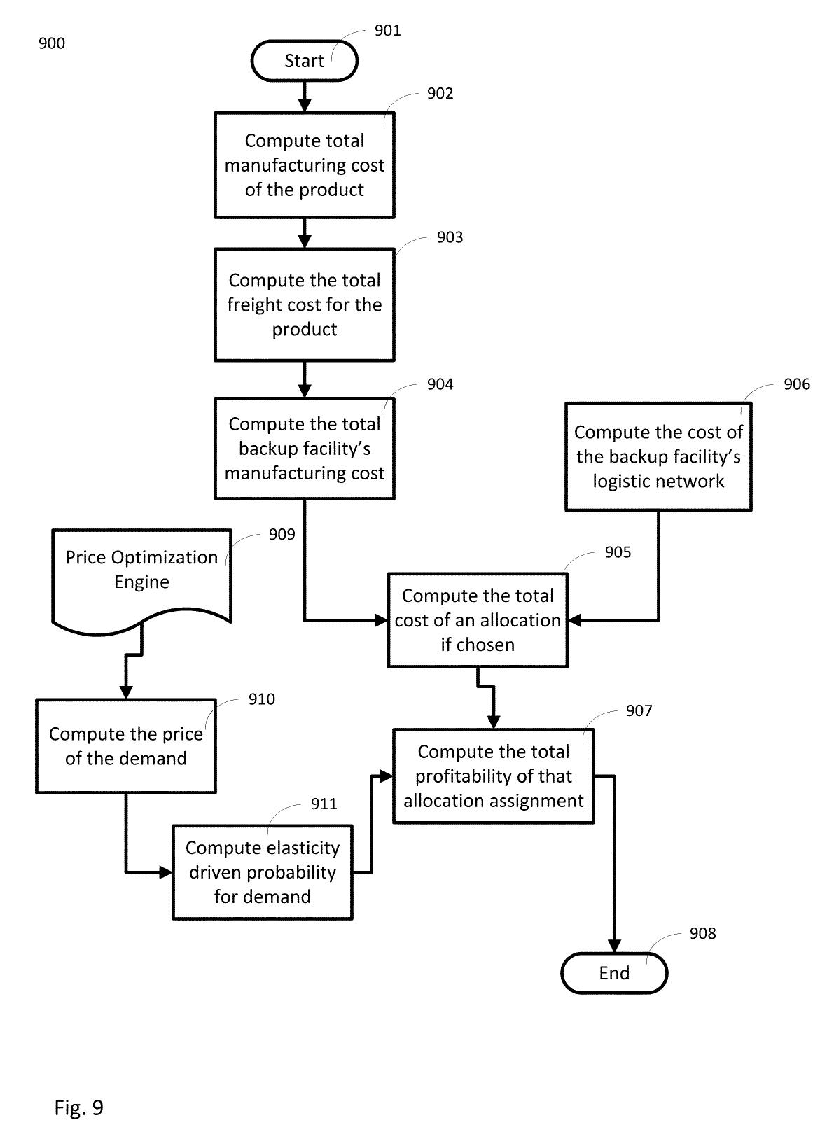

FIG. 9 is an embodiment of the system as it illustrates a method of computing profitability of a certain solution 900 that is determined to be feasible by the output of FIGS. 7 and 8. Upon starting 901, the first step in the process computes the total manufacturing cost of the product 902 based on the various cost elements provided in the input data as shown in FIG. 3. This is then followed by the computation of the freight cost of the product on a particular transportation route 903. For every backup production facility and transportation solution, a cost based on its manufacturing cost 904 and the logistical cost 905 is computed. These computations are then combined to calculate the total cost of all solutions: primary and backup 905. Meanwhile the price optimization engine computes the price of a stated demand 910 and computes the elasticity and probability of the demand 911. Both the information is combined to compute the profitability of the allocation assignment 907.

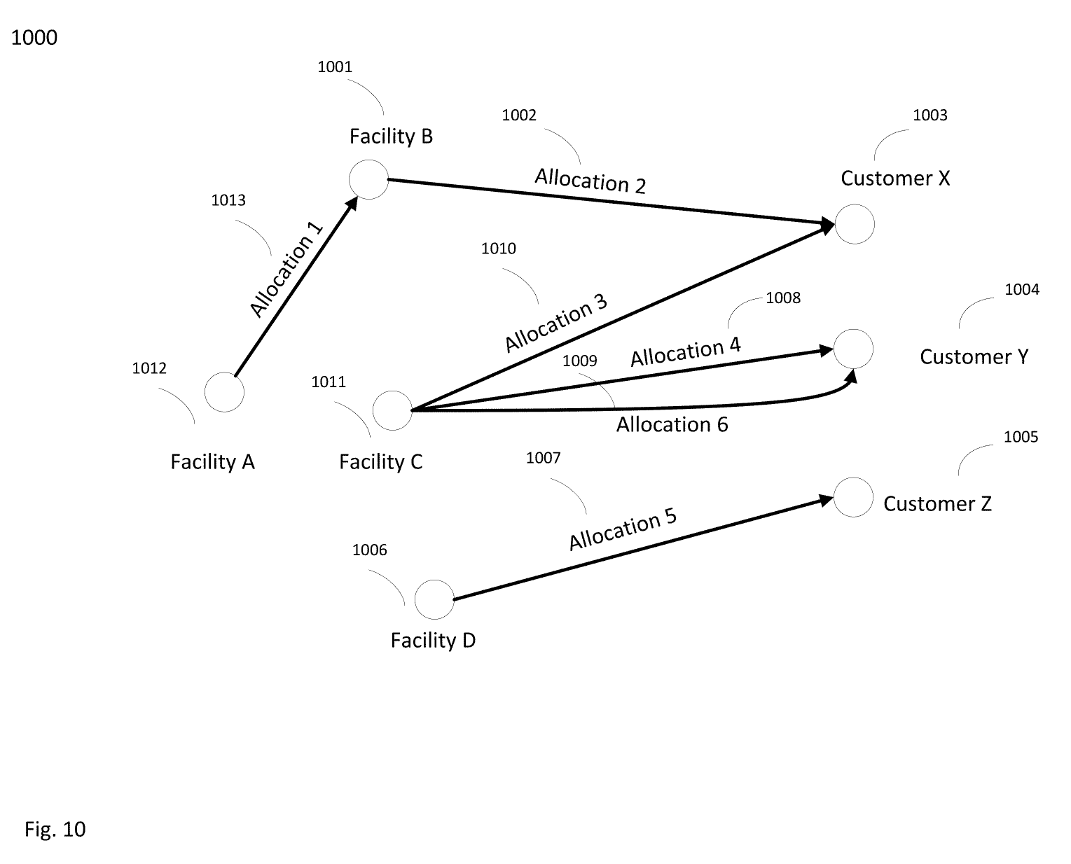

FIG. 10 illustrates a graphical representation of the network of facilities and customers 1000 and product resource allocations within such network. The graph consists of nodes (represented by circles) and arcs (represented by arrows). A node represents an entity such as a production facility or a customer. An arc represents a flow of products between two nodes. An arc or a combination of arcs is a representation of a feasible resource allocation that is evaluated by the optimization system for profit-optimality. FIG. 10 illustrates different types of allocation that can exist within the network of production facilities and customers. For example, Allocation 1 (1013) and Allocation 2 (1002) represent a resource allocation wherein Facility A (1012) manufactures the product demanded by customer X (1003) and is transported along the arc 1013 to Facility B (1001). The products then get transported on the arc labeled ‘Allocation 2’ (1002) to the customer X (1003). Another type of resource allocation is represented by Allocation 5 (1007) where Facility D (1006) manufactures the product and supplies directly to the customer Z (1005) along the arc 1007. Customer X (1003) represents a customer with a large demand that exceeds the capacity on a single facility and can be supplied partially by two facilities along two arcs. (1002 and 1010). The arcs 1009 and 1008 represent multiple transportation systems that can exist between a facility and a customer. Hence Customer Y 1004 can be supplied through 2 different allocation routes represented as ‘Allocation 4’ and ‘Allocation 6’. Usually, it is profit-optimal to choose a single allocation mechanism between a customer and a production facility.

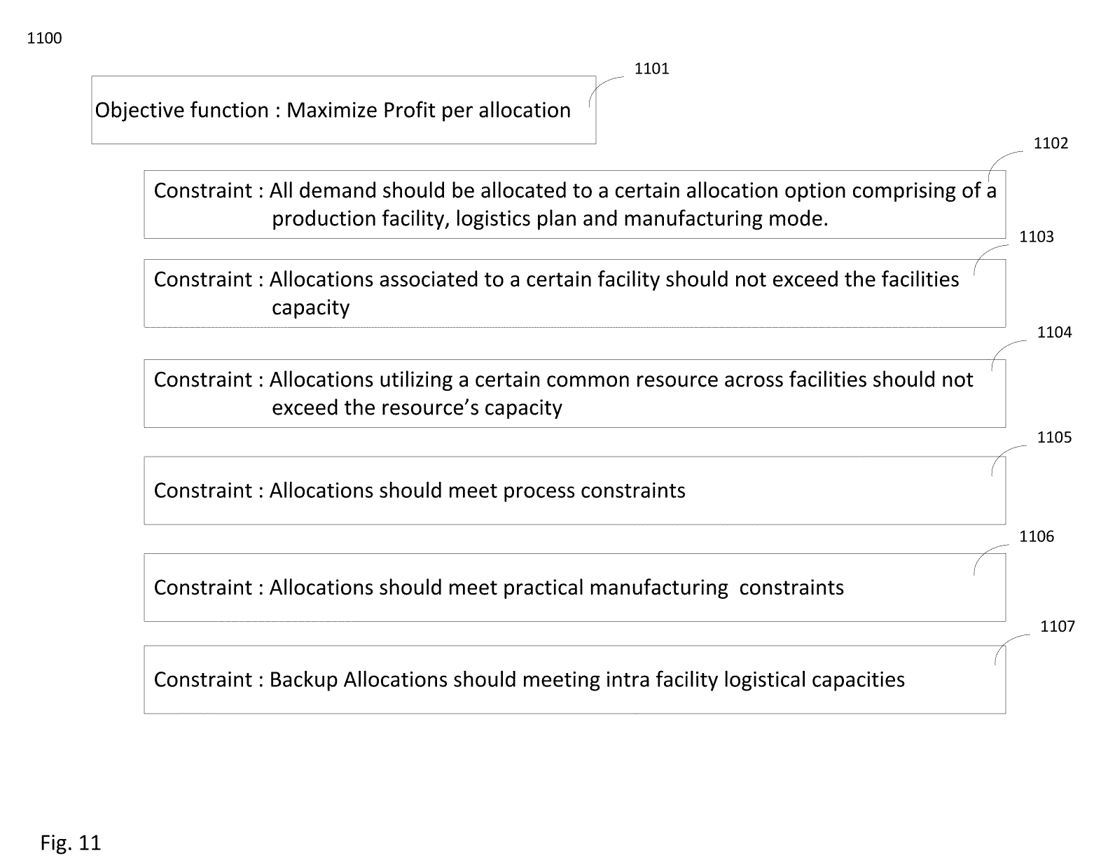

FIG. 11 is an embodiment of the system and illustrates a mathematical framework that represents the allocation solution optimization problem across the many facilities and customers in the supply chain network 1100. A mathematical framework for an optimization problem usually consists of an objective function 1101 and constraints including but not limited to the ones described in 1102, 1103, 1104, 1105, 1106, and 1107. In this example, the objective function 1101 is stated to maximize the profitability across all allocations. It is subjected to constraint 1102 that states that allocation solutions should be chosen such that all demand for each time period is satisfied. It is subjected to constraint 1103 that states that the allocations chosen should not exceed a facility's capacity. An additional constraint 1104 states that allocations utilizing a common resource including but limited to machines should not exceed its stated capacity. Constraint 1105 represents the complex process constraints that exist within the production facility's manufacturing process. For example a process constraint within the production facility's manufacturing process may be a constraint on the type and volume of product that can be packaged in the facility. Constraint 1106 represents the practical manufacturing constraints that exist which includes but is not limited to constraints that need to keep a count on certain product types or limits on the number and types of production methods that may be used at a time based on tooling and storage constraints at the production facility. Constraint 1107 represents a capacity constraint on all the backup resources inclusive of the transportation constraints such as limits on the number of shipments between two productions facilities that are used across multiple allocations.

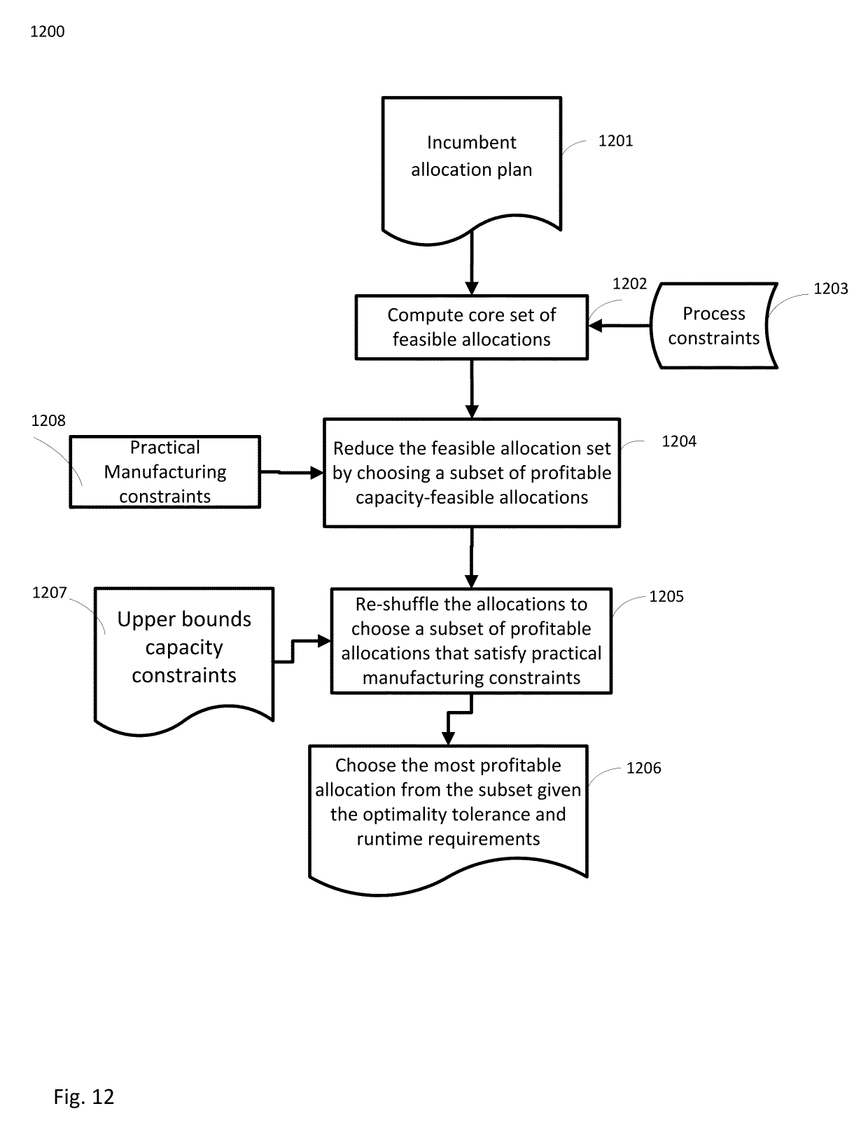

FIG. 12 represents the optimal capacity allocation engine that uses the mathematical framework (shown in FIG. 11) to search through the feasible options to find the set of most profit-optimal resource allocation solutions 1200 (FIG. 2, 210). The engine reads the incumbent solution plan 1201 and compares it against the feasible set of allocation solutions that was computed by the feasible solution generator shown in FIG. 7. Process constraints 1203 are taken into consideration and the engine computes a core set of feasible allocations 1202. The set is continuously replaced with profitable feasible allocations 1204 taking into consideration practical manufacturing constraints 1208. The allocations in the set are re-shuffled to satisfy capacity bounds 1207 and the engine continues to search for feasible and more profitable allocations 1205. The resulting solution set represents the most profitable resource allocation given that all constraints are satisfied 1206.

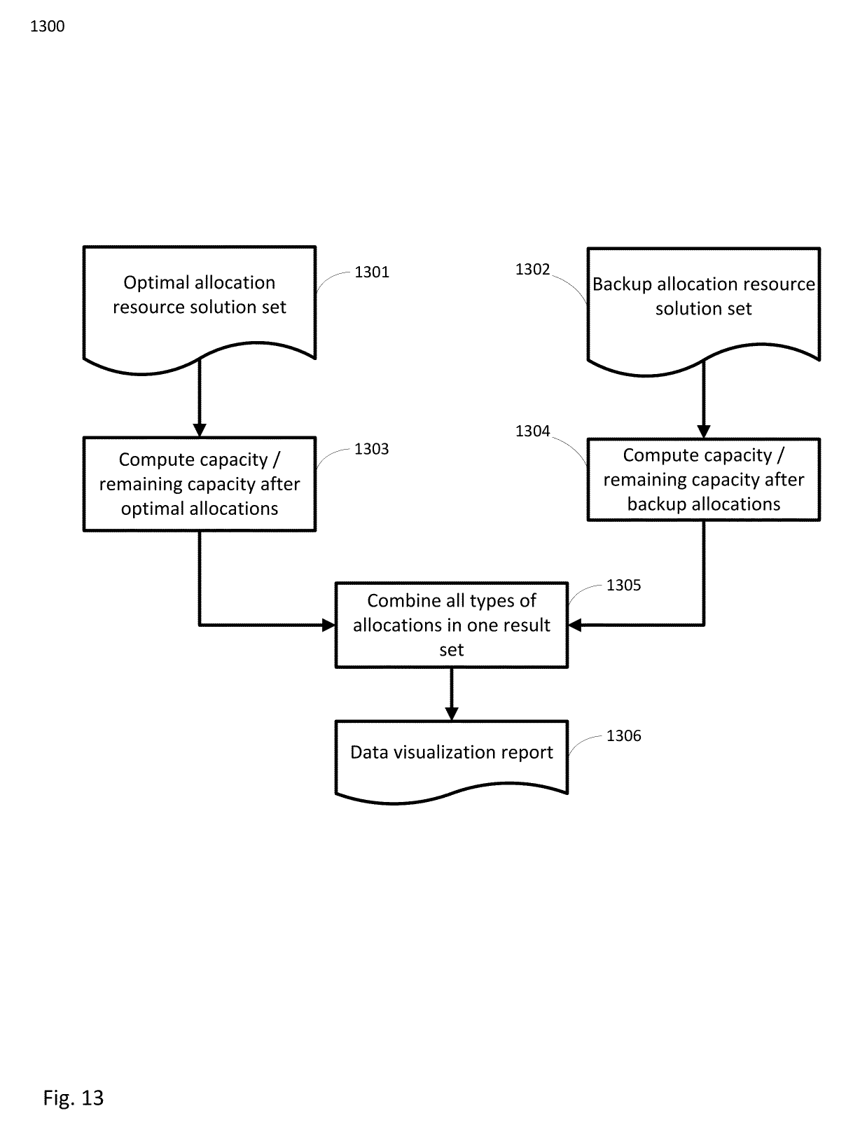

FIG. 13 is an embodiment of the system and illustrates the function workflow of the output data preparation engine 1300 (FIG. 1, 107). The optimal allocation resource solution set 1301 and the backup allocation resource solution set 1302 is used to compute utilization metrics including but not limited to capacity and remaining capacity on all entities including but not limited to production facilities and internal/shared resources. (1303 and 1304). These results are combined into one set of allocation (1305) that is passed on to the data visualization report (1306) in order to be communicated to the user.

FIG. 14 represents the functional workflow of the data management user interface 1400 that comprises of a user interface (UI) 1401 (FIG. 1, 102). This allows the user to modify capacity constraints 1402, process constraints 1403, manufacturing constraints 1404 and the incumbent allocation plan 1405. The modification process is handled internally within the data management user interface. The user specifies configuration values on each screen that are used to modify the appropriate columns across the entire dataset. Once the user is satisfied with the data modifications, the output data is compiled into files of type including but not limited to text, csv, etc. of format including but not limited to pipe-delimited, comma separated, etc. and sent to the FTP server.

FIG. 15 shows an exemplary embodiment of the graphical representation of the data management user interface 1500. This embodiment 1501 represents the ‘mill capacities’ tab where capacities of each mill can be altered by specifying the configuration value ‘capacity adjustment’ 1510 (see also FIGS. 3, 305, 306 and 307). The buttons 1511 and 1512 allows the user to control the modification to a single month to multiple months. 1502 represents the machine capacity tab that allows modification of the capacity information for a machine which is an example of an internal/shared resource across production facilities. 1503 represents the demand tab that allows modifications of the demand data flowing into the system. 1504, 1505 and 1506 represent the various screens that allow for the modification of constraints within the optimization system.

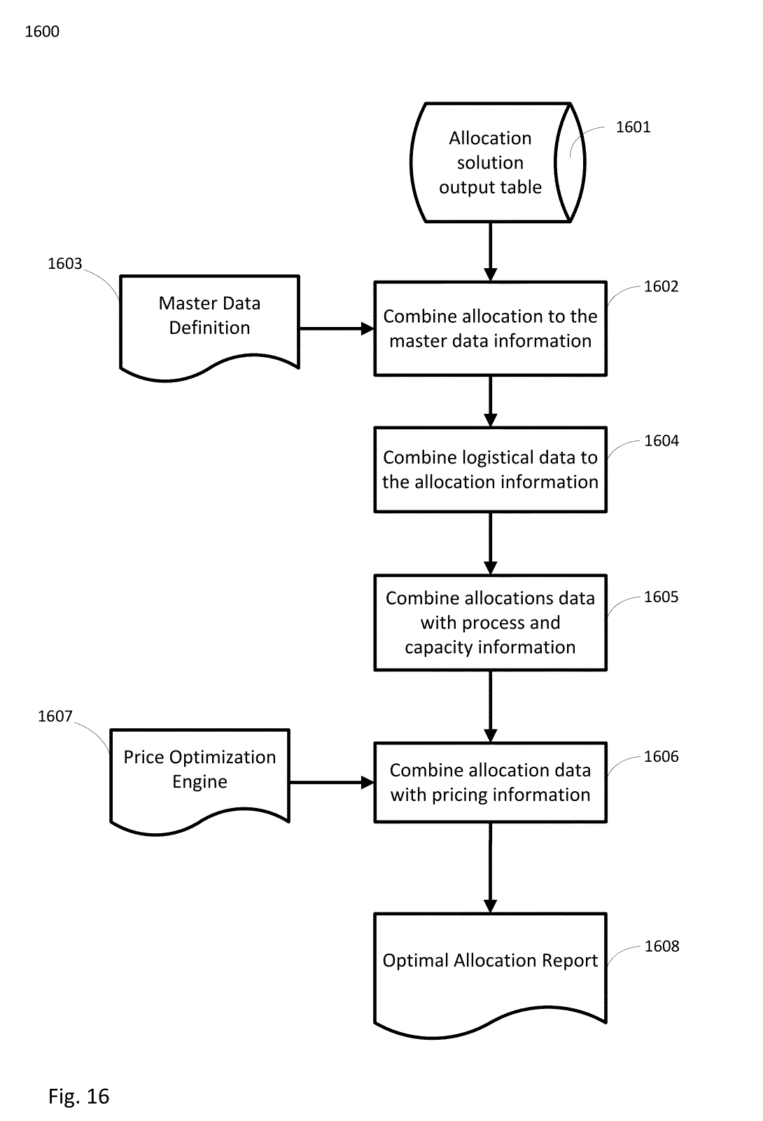

FIG. 16 represents the functional workflow of the data visualization engine 1600 (FIG. 1, 108). Allocation solution output table 1601 is a table that contains values from the output of the optimal capacity allocation engine. Master data definitions 1603 are combined with allocation information 1602. Logistical data is added to the combined allocation information and master data 1604. Further process and capacity information is combined with the allocation information 1605. Pricing information is read from the price optimization engine 1607 and combined with the allocation data 1606 to compute profits that can be reported which may be in accordance with the system and method set forth in U.S. patent application Ser. No. 13/766,552 or another applicable optimization method. The final dataset is passed to create the optimal allocation report 1608.

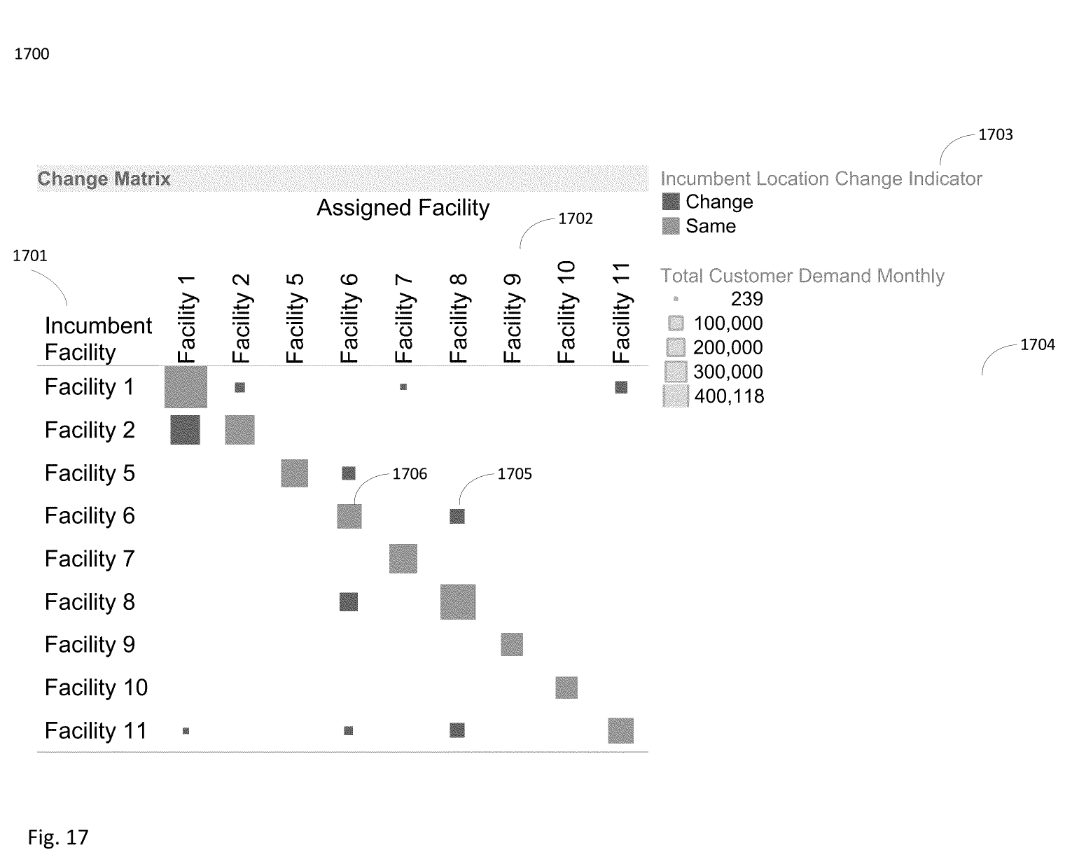

FIG. 17 is an exemplary embodiment of the system and is a representation of the resource allocation solutions change matrix 1700. This is a visual representation of the profit-optimal resource allocations. 1701 represents a column indicating incumbent production facilities and 1702 represents the recommended production facilities. Total customer demand on a monthly basis is show 1704. The box 1705 represents the total dollar amount of benefits that can be realized with change in resource allocations from the incumbent production facility to the recommended production facility. 1703 represents the color legend of the different types of allocation decisions. The box with the color indicated by 1706 represents the decision that the incumbent allocations were most profit-optimal resource allocations.

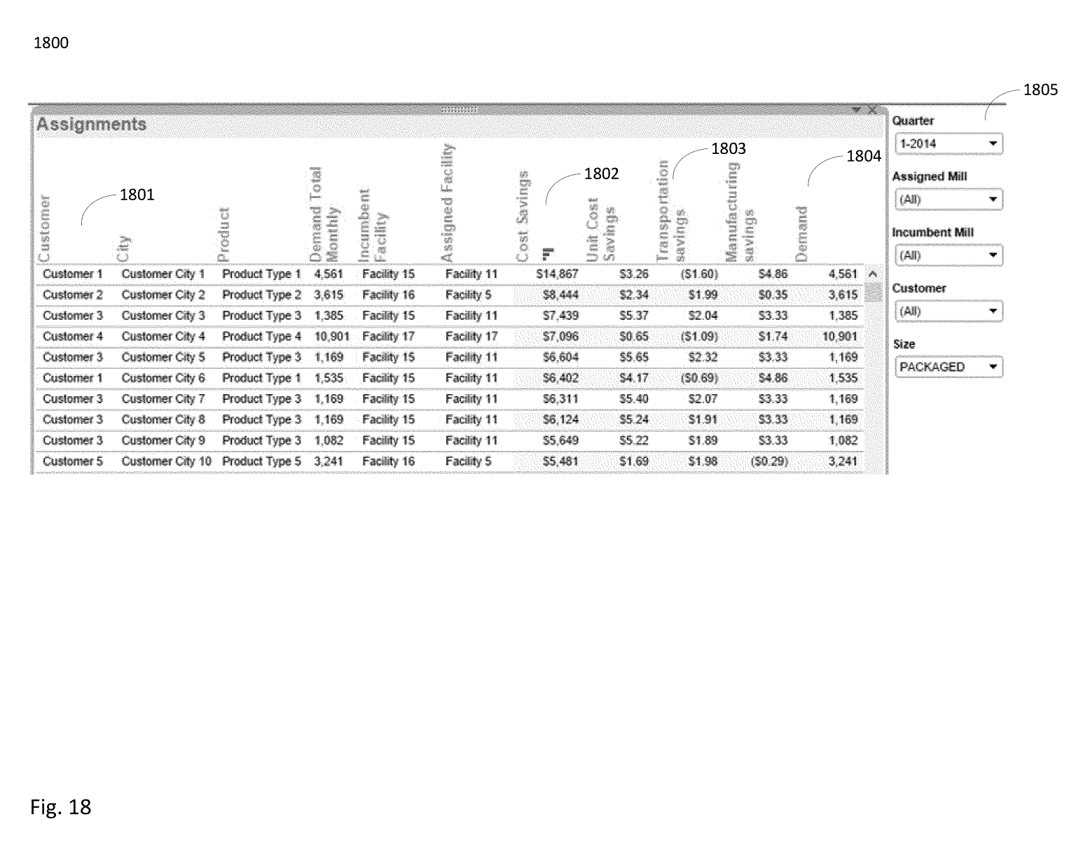

FIG. 18 is an exemplary embodiment of the system and illustrates optimal capacity resource allocation solution opportunities 1800. A list 1804 of recommended resource allocation solutions per customer-product combination is shown. Customer names and their details are shown 1801. Cost savings associated with the given allocation per month are shown 1802 and 1803. The demand associated with each resource allocation solution is shown 1804. The time period in consideration of the list is shown 1805.

FIG. 19 is an exemplary embodiment of the system and shows alternative options for a customer and product opportunity 1900. It highlights the details of a single resource allocation 1901. The graphic shows a detailed view of the incumbent flag 1902 that indicates whether the production facility is a part of the incumbent allocation plan (existing or planned) or if it is a challenger (backup) allocation plan that was considered by the optimization system. The production mode that was considered by the optimization engine is shown 1903. Cost savings and the associated cost of each option are displayed in columns 1905 and 1904 respectively. The recommended demand that is allocated to each of the challenger allocation option is shown 1906. The embedded smaller view 1911 shows the capacity utilization of the associated product facility. The monthly demand of the customer 1910 is shown. Constraints associated with the option are shown 1908. The capacity utilization of the internal/shared resource if utilized by the current allocation is shown 1912.

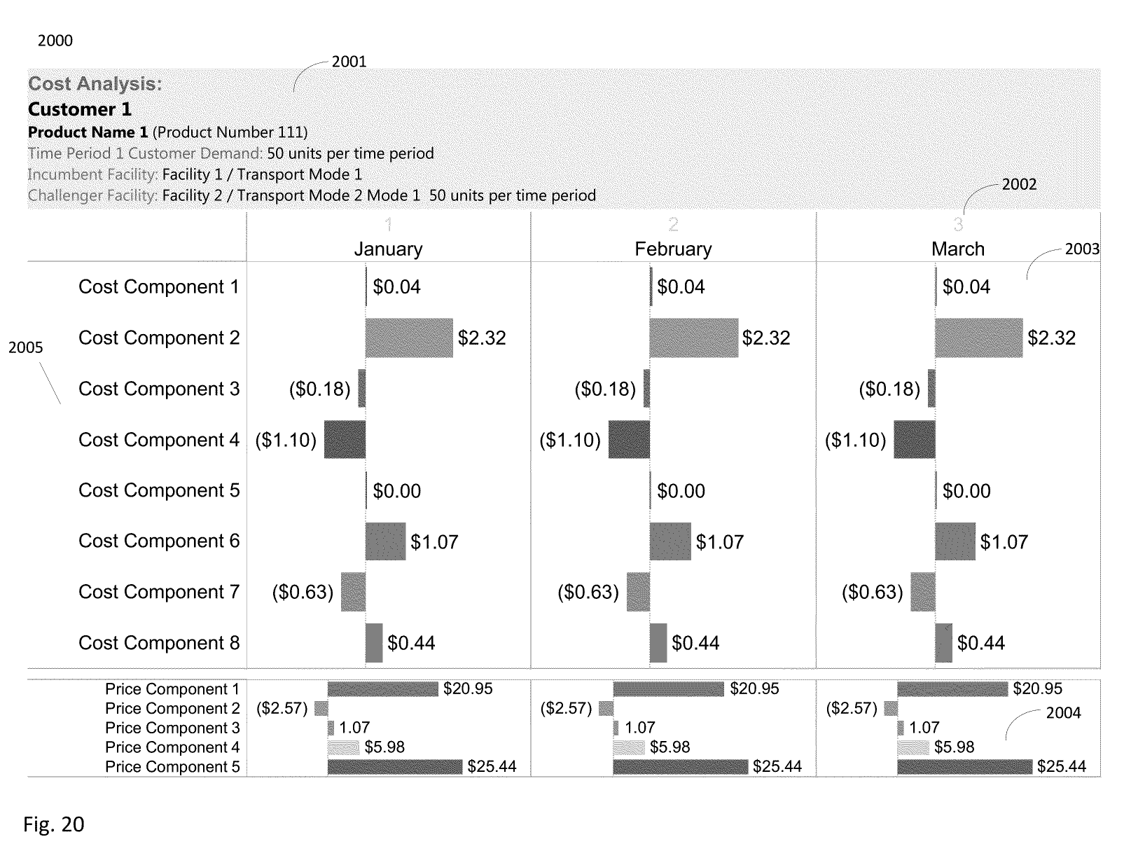

FIG. 20 represents an exemplary embodiment showing a cost breakdown analysis for a particular opportunity using a graphic detailing the various cost components of the resource allocation solution decision 2000. It shows the cost difference of the incumbent and the challenger allocation solution for all the given cost components illustrated in 2005. A header representation of the customer associated with the demand is shown 2001. The components that are added to compute the price of the demand from the market are shown 2004.

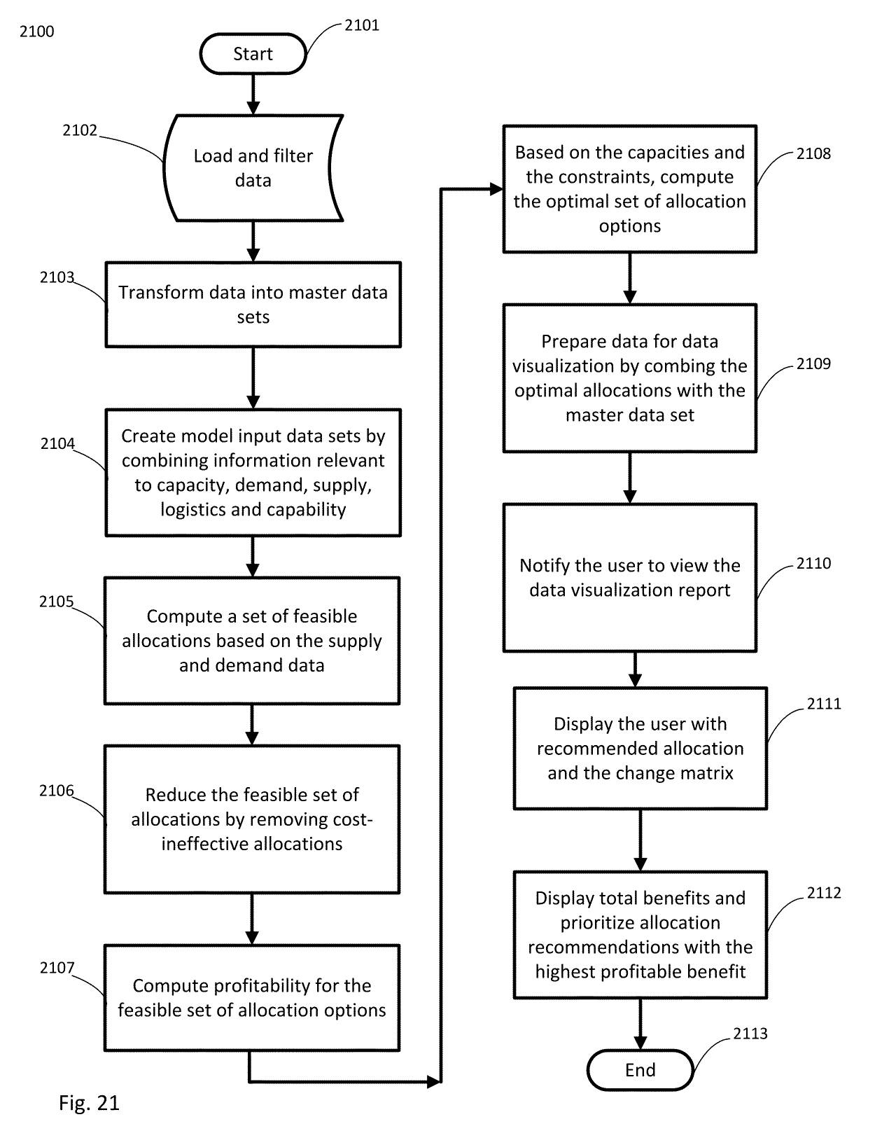

FIG. 21 is a representation of the overall methodology of the system 2100. It starts 2101 with the loading and filtering of the various data components 2102 and that are then is transformed into master datasets 2103. The master datasets are transformed to create model input data sets by combining all the components of the supply and demand data 2104. The engine computes the set of feasible allocation solution options 2105 and then reduces the set to the most cost-effective options 2106. Each allocation solution within the reduced set is used to compute profitability 2107 associated with each one of them and then based on the capacity and other constraints, the profit-optimal set of allocation options is computed 2108. The output data is used as an input into the data visualization engine by combining it with the master dataset 2109. The user is then notified via an email 2110 that the results are available for review and use. The user uses the data visualization report to view the recommended allocations and the change matrix 2111. The total benefits and allocations prioritized by cost savings and profitability projections are reported to the user 2112 through a report.

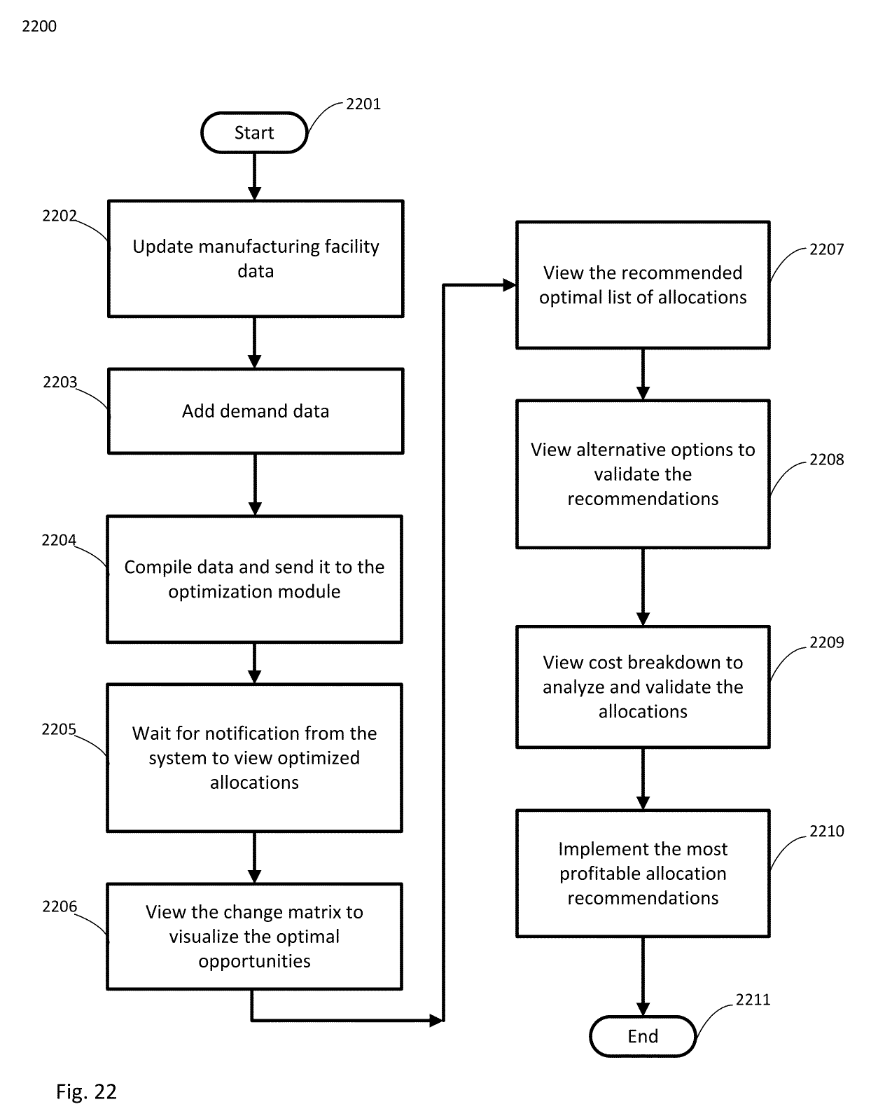

FIG. 22 represents the user interaction workflow diagram of the system 2200. The user starts 2201 by updating the manufacturing facility data 2202 and then continues to add demand data 2203. The next step comprises of compiling the data and sending it to the optimization module 2204 via the data management user interface. As the optimization system executes the computer executable instructions, the user waits for the notification of the process completion 2205. Once the notification email arrives, the user can view the change matrix to visualize the optimal allocation opportunities 2206. The user then can view the recommended allocations through a list 2207. The next step is to view the alternative options to validate the usability of the recommendations 2208. The cost breakdown can be analyzed 2209 and then the user implements the most profitable resource allocations 2210.

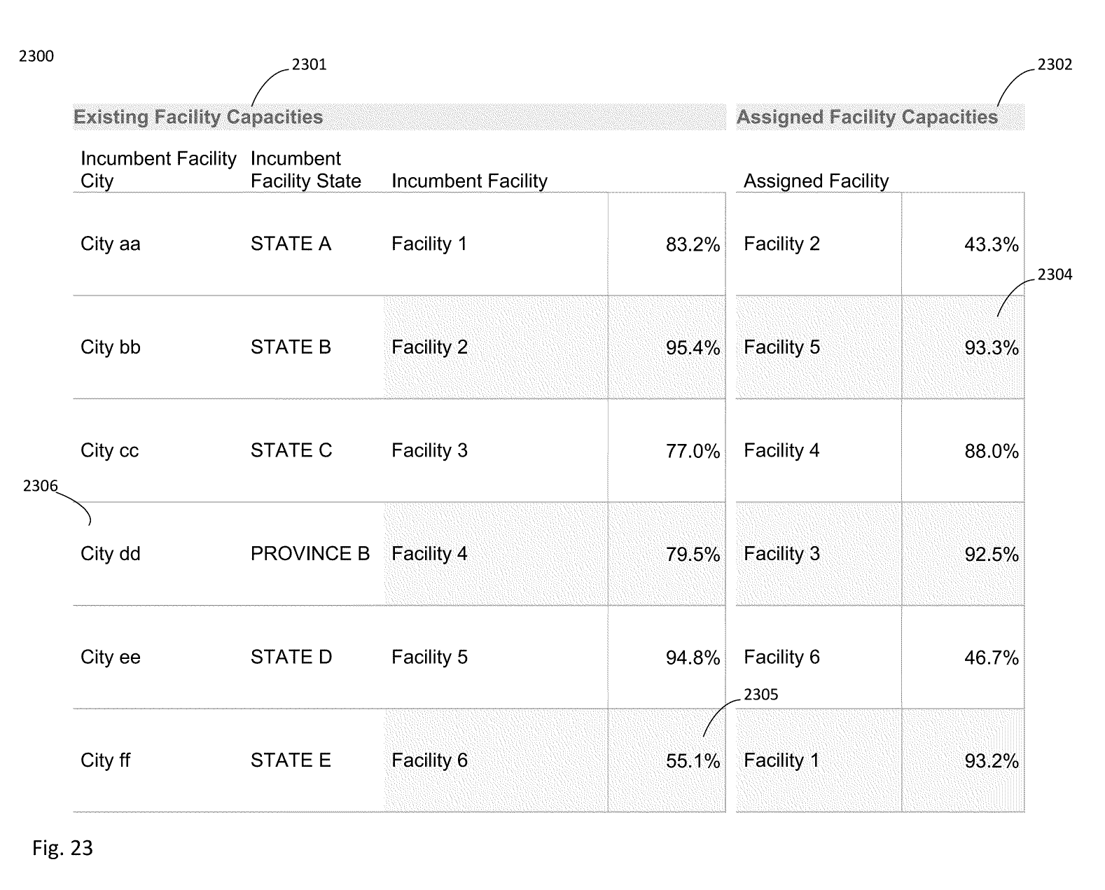

FIG. 23 is an exemplary embodiment of the system and represents the overall capacity utilization of the various entities within the mathematical framework inclusive of the facilities and the internal/shared resources including but not limited to machines. A comparison of the utilization when the incumbent allocation plan was in use, with the recommended profit-optimal resource allocation plan is shown 2301 along with assigned facility capacities 2302. 2306 represents the list of production facilities and 2305 and 2304 represents the resource utilization percentage.

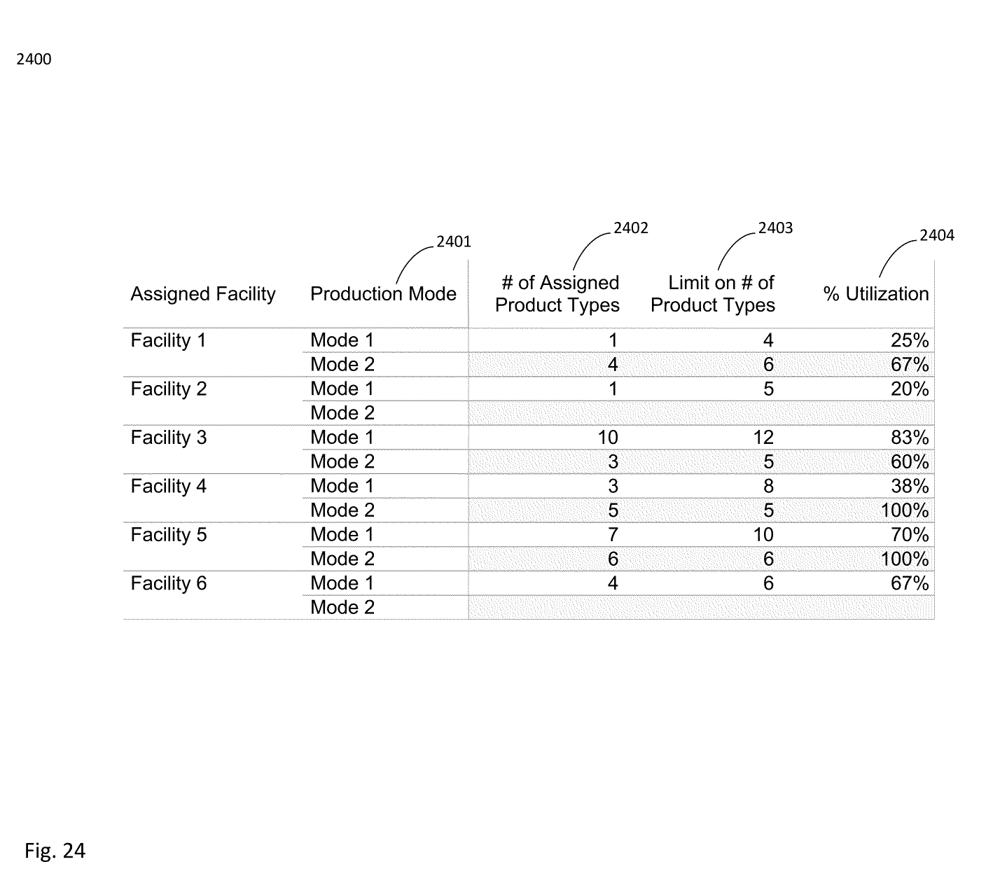

FIG. 24 is an exemplary embodiment showing a visual graphic representation of the various processes and manufacturing constraints and its associated utilization post optimization 2400. The production model is shown 2401 along with the unique counts of the constraints used in the optimization system 2402, 2403 and 2404.

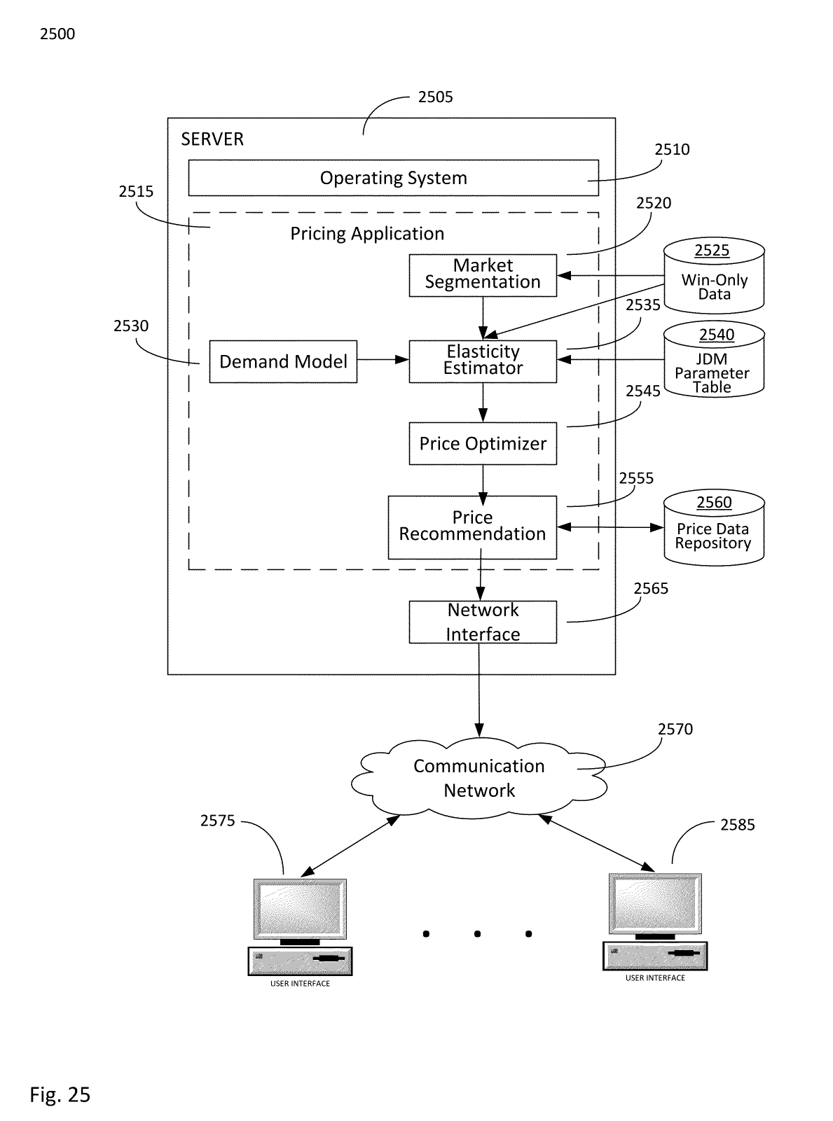

FIG. 25 depicts a computer system and network suitable for implementing the system for determining price optimization as part of the price optimization engine (FIG. 4, 408; FIG. 5, 504; FIG. 9, 909). FIG. 25 depicts a computer system and network 2500 suitable for implementing the system and method for determining price recommendations. A server computer 2505 includes an operating system 2510 for controlling the overall operation of the server 2505, which connects to user interface devices 2575, 2585 via a server/network interface 2565 and a communication network 2570. A software-implemented pricing application 2515 resides in the server 2505 and accesses win-only transaction data 2525 and joint demand model parameter table data 2740 from data storage devices for use by a market segmentation function 2520, an elasticity estimator 2535 and a price optimizer 2545, respectively. The elasticity estimator 2535 also receives data from a demand model 2530. A price recommendation function 2555 receives data from the price optimizer 2545, may store price recommendations in a price data repository 2560, and communicates the price recommendations to user interface devices 2575, 2585 via a network interface 2565 and a communication network 2570.

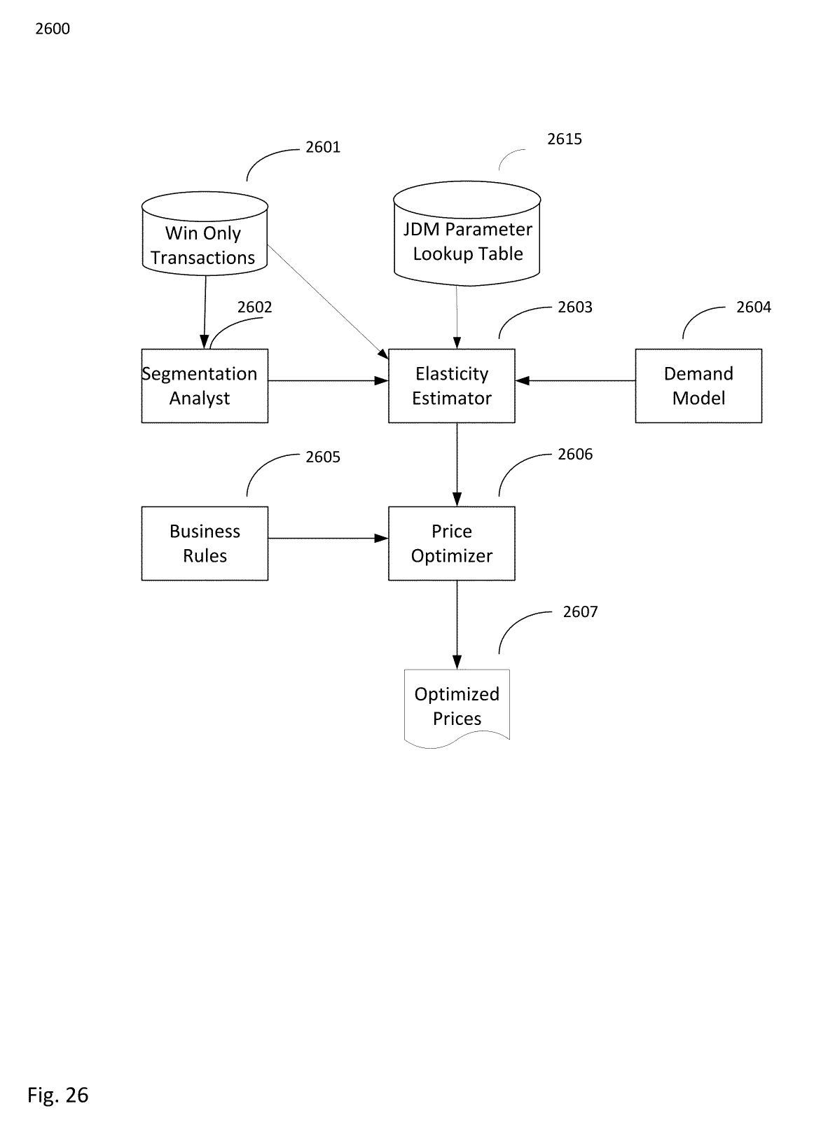

FIG. 26 is a functional block diagram illustrating a computer implemented system and method for determining pricing recommendations 2600 as part of the price optimization engine. Win-only transactions data 2601 is used to perform segmentation analysis 2602 where each market segment is defined by a collection of product, customer, order, and geographical attributes. Each market segment is considered to have the same response to price changes, where the attributes selected for use in market segmentation can be determined through a number of methods, included but not limited to a statistical analysis of historical transactions. The win-only transactions data 2601 is also used by an elasticity estimator 2604. The elasticity estimator 2604 uses the win-only transaction data, in conjunction with an assumed demand model 2603 to calculate elasticities 2604 for each market segment. The demand model 2603 may be the Joint Demand Model that includes both an offer model and a demand model. The price optimizer 2606 uses the output from the elasticity estimator 2604 in conjunction with business rules 2605 to determine optimized prices 2607. The optimization may be formulated as a Profit or Revenue maximizing objective, where the demand model is used within the optimization problem to determine the expected number of units sold from either an increase or decrease in a market segments price.

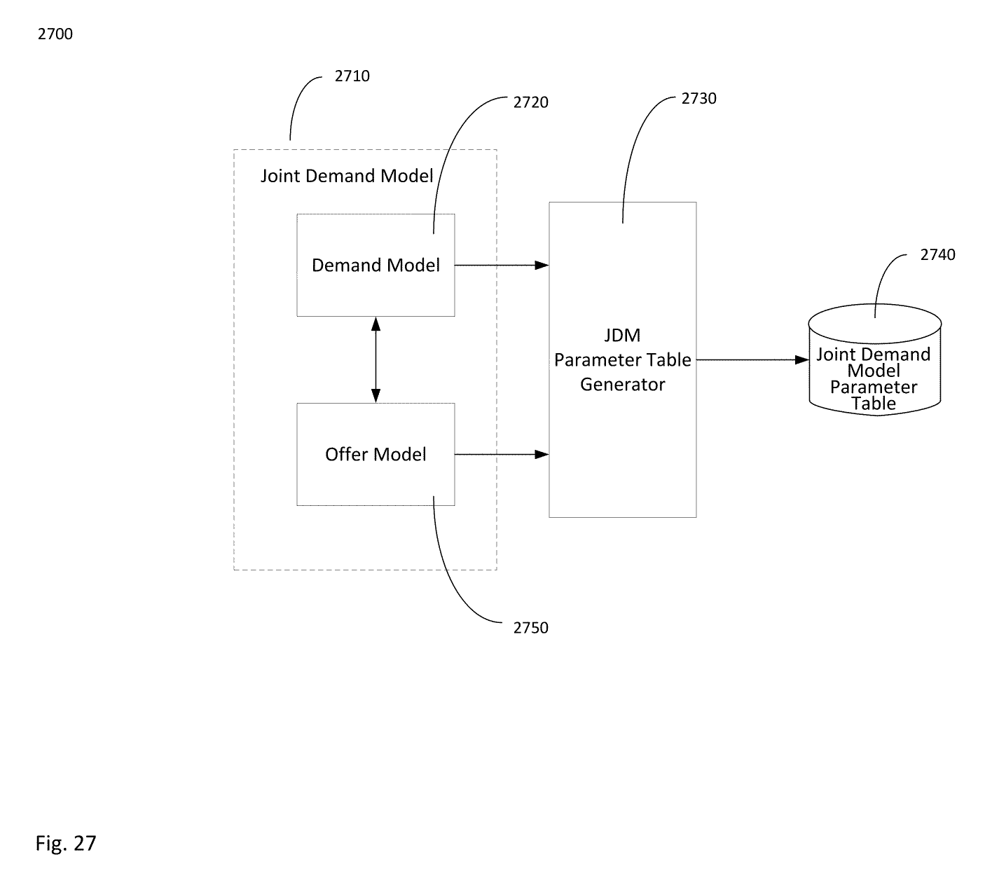

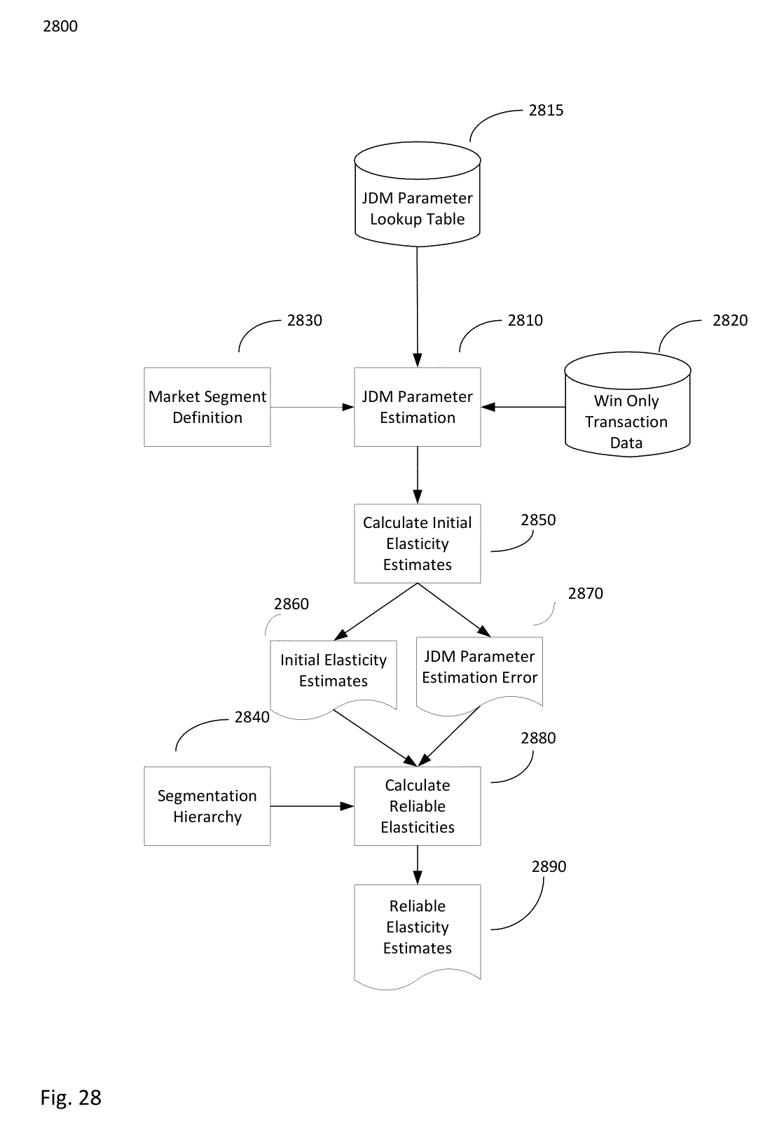

FIG. 27 is a functional block diagram illustrating one embodiment of a system and method 2700 for constructing a joint demand model lookup table used to efficiently estimate the parameters of the joint demand model of the price optimization engine. Although many types of demand models may be used in the system and method for determining pricing recommendations, the particular embodiment shown in FIG. 27 comprises a joint demand model 2710 in which both a demand model 2720 and an offer model 2750 are utilized. In the joint demand model 2710, the observed sales transactions are assumed to be win-only transactions (FIG. 28, 2820) resulting from the customer's willingness-to-pay convoluted with the prices offered by the sales person. If the joint demand model 2710 accurately reflects the sales process, the distribution of win-only transaction data should closely resemble the distribution predicted by the joint demand model.

In this particular embodiment of the joint demand model of the price optimization engine, the buyer is assumed to accept an offer if the offered price is less than the buyer's willingness to pay. The willingness-to-pay of the population of customers is assumed to be distributed according to the logistic distributions. The probability density function of willingness-to-pay distribution can be represented as follows.

$$f ( p ) = \frac{b {e}^{- b ( p - {p}_{0} )}}{{( 1 + {e}^{- b ( p - {p}_{0} )} )}^{2}}$$

Where p is the price and the demand model parameter p₀ represents the mean of the willingness-to-pay distribution and parameter b is proportional to the inverse standard deviation of the willingness-to-pay distribution.

The particular embodiment of the joint demand model 2710 assumes an offer model 2750 distributed according to a truncated logistic distribution, with the same demand model parameters b and p₀ as the assumed willingness-to-pay distribution. This assumption implies that the salesperson has some knowledge about the willingness-to-pay of the population of customers. In addition, the lower truncation is meant to represent a floor price, where perhaps the cost to produce the product is greater than the price offered. In the offer probability density function, where the price p₁ represents the floor on offered prices.

The combination of the logistic willingness to pay distribution and the lower truncated logistic offer distribution can be represented by the following probability density function.

$$h ( p ) = \frac{2 {( 1 + {e}^{b ( {p}_{1} - {p}_{0} )} )}^{2} ( b {e}^{b ( p - {p}_{0} )} )}{{( 1 + {e}^{b ( p - {p}_{0} )} )}^{3}} for p \geq {p}_{1} else 0$$

There are several ways to estimate the demand model parameters b, p₀, and p₁ using win-only data which is assumed to conform to the implied transaction density. Some methods are more numerically efficient than others. For instance, the maximum likelihood approach can be applied, but a closed form solution to the maximum likelihood optimization problem is unknown and the method results in a computationally intensive process. A moment matching technique is another traditional parameter estimation technique. Unfortunately, a closed form solution to the inverse moments formulas are unknown. Fortunately, a JDM parameter table generator 2730 can be used to pre-generate a JDM parameter lookup table 2740 which may be based on the moment matching technique. The JDM parameter lookup table 2740 can then be used to find the demand model parameters b, p₀, and p₁ which match the sample moments, such as the sample mean and sample variance, of the observed win-only transaction data. The use of a lookup table results in a much more computationally efficient method than the maximum likelihood approach, where the particular embodiment described assumes that the lower truncation point p₁ is known.

FIG. 28 is a functional block diagram illustrating the elasticity estimator which relies upon a pre-generated joint demand model parameter lookup table of the price optimization engine. Win-only transaction data 2820 is retained in data storage and is used by the joint demand model parameter estimator 2810. The joint demand model parameter estimator 2810 also uses the market segment definition function 2830 and the joint demand model lookup table 2815 to compute an estimate of the joint demand model parameters 2810 and parameter estimation error for the defined market segments. The joint demand model parameter estimates are used to calculate initial elasticity estimates. Reliable elasticities are calculated 2880 using the initial elasticity estimates 2860 and the parameter estimation error 2870, combined with the segmentation hierarchy 2840 to produce the reliable elasticity estimates 2890. The reliable elasticities 2890 are calculated using a weighting scheme using the segmentation hierarchy 2840.

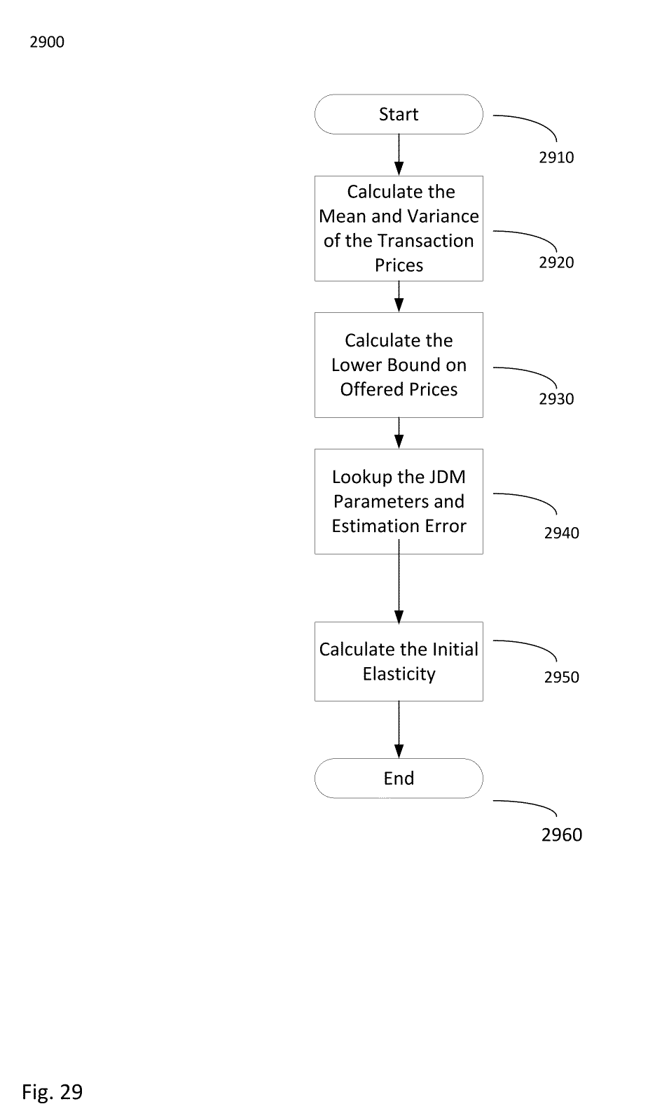

FIG. 29 is a flow diagram representing the JDM parameter estimator of the price optimization engine. Upon start 2910 for a defined market segment, the sample mean and sample variance of the transaction prices are calculated 2920. The parameter p1 is also calculated, where one such method for calculating the lower bound on transaction prices is to take the minimum transaction price in the defined market segment (calculate the lower bound on offered prices) 2930. The sample mean, sample variance, and the lower truncation value are then used to lookup the joint demand model parameters b and p0 using the joint demand model parameter lookup table 2940. The joint demand model parameter lookup table also provides the estimation error of the joint demand model parameters b and p0 2950. The elasticity ε at price p0 can then be calculated using the following well known formula defined for the logistic willingness-to-pay distribution 2950.

ε=½·b·p_{—}0

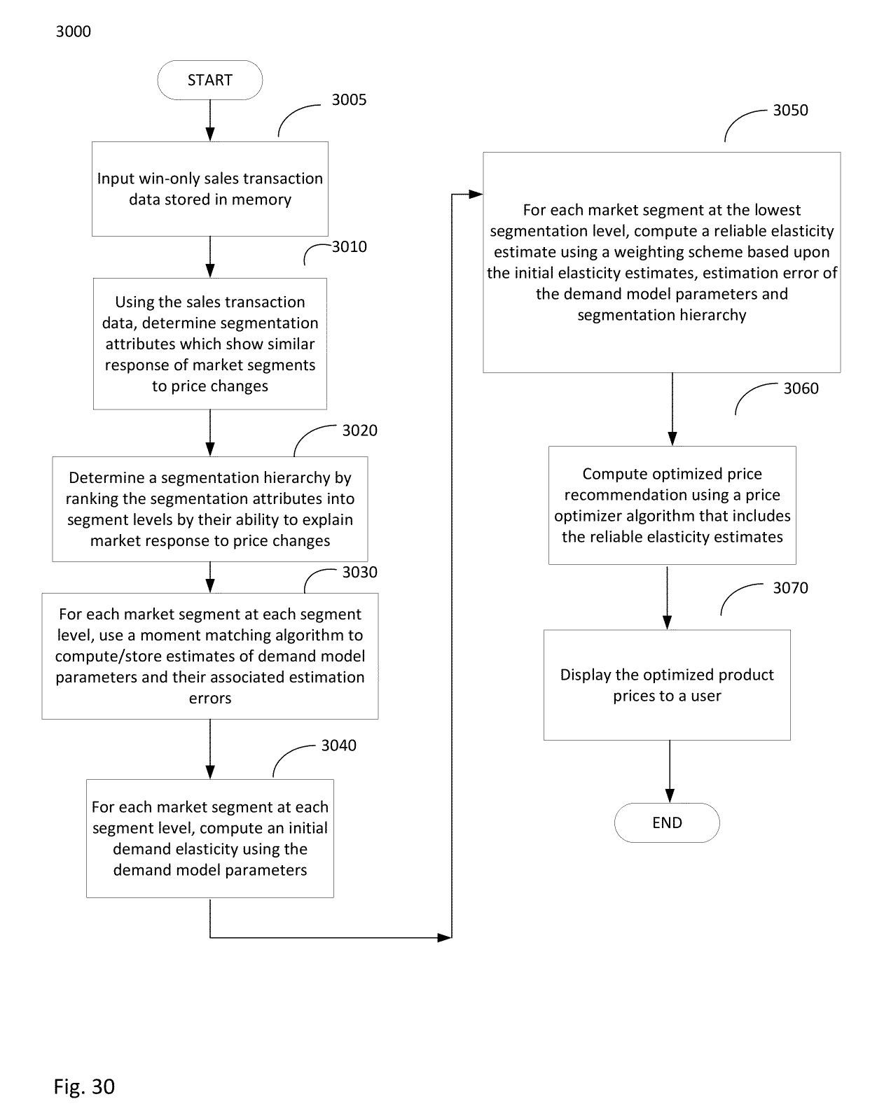

FIG. 30 is a flow diagram of an exemplary embodiment of the method for determining optimized product price recommendations 3000 as part of the price optimization engine. The method is implemented by computer-executable instructions being executed by a computer processor. Sales transaction data stored in memory for one or more products is inputted 3005. The sales transaction data comprises observed win-only sales transactions for a business. Using the sales transactions, segmentation attributes are determine which define market segments that have similar responses to product price changes 3010. The segmentation attributes are then ranked into a segmentation hierarchy based on the segmentation attributes ability to explain the market response to price changes 3020. The segmentation hierarchy defines market segments at each level in the hierarchy. For each market segment at each segment level, use a moment matching algorithm to compute and store estimates of the demand model parameters and compute and store their associated estimation error 3030. For each market segment at each segment level, compute an initial demand elasticity using the demand model parameters 3040. For each market segment at the lowest segmentation level, compute a reliable elasticity estimate using a weighting scheme based upon the initial elasticity estimates, the estimation error of the demand model parameters, and the segmentation hierarchy 3050. Optimized price recommendations are computed using a price optimizer algorithm that includes the reliable elasticity estimates 3060. The product price recommendations are then displayed to the users 3070.

Some embodiments of the system are implemented as a program product or computer system apparatus for use with a computer system such as, for example, the system shown in FIG. 1. The program product could be used on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present system, represent embodiments of the present system.

In general, the routines executed to implement the embodiments of the system, may be part of an operating system or a specific application, component, program, module, object, or sequence of instructions. The computer program of the system typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the system. However, it should be appreciated that any particular program nomenclature that follows is used merely for convenience, and thus the system should not be limited to use solely in any specific application identified and/or implied by such nomenclature.

In addition, embodiments of the system further relate to computer storage products with a computer-readable medium that have computer code thereon for performing various computer-implemented operations. The media and computer code may be those specially designed and constructed for the purposes of the system, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although the system has been described in detail with reference to certain preferred embodiments, it should be apparent that modifications and adaptations to those embodiments might occur to persons skilled in the art without departing from the spirit and scope of the system.

What is claimed is:

1. A computer system apparatus for maximizing expected product profit for a product by identifying optimal allocations of production resources comprising:
a server having a computer processor coupled to a memory wherein the memory stores a computer program, that identifies profit optimal allocations of production resources for a product, when executed by the processor causes the processor to:
input into memory a distribution of prices across a customer base for the product, wherein the distribution of prices for the product is computed using a price optimization engine;
input into memory elasticity of demand for defined market segments across the customer base for the product wherein the elasticity of demand for the defined market segments is computed using the price optimization engine;
input into memory the probability of demand for the product converting into a sale;
input into memory configuration parameters for production resources using a configuration parameter engine running on the processor;
input into memory supply and demand data for the product from a computer store using a supply and demand engine running on the processor;
combine the distribution of prices for products, the elasticity of demand for the defined market segments, the probability of demand of the product converting into the sale, the configuration parameters with the supply and demand data and output a preprocessed dataset using an algorithm running in a data preparation engine running on the processor;
input into memory one or more incumbent capacity allocation solutions for the product that represents a previous optimal allocation of the production resources for the product;
receive and combine the preprocessed dataset and the incumbent capacity allocation solution for the product into a combined candidate allocation solution dataset using a data preprocessing engine running on the processor;
receive the combined candidate allocation solution dataset and compute feasible resource allocation solutions for the product for a specified time period using a resource solution generator running on the processor coupled to the data preprocessing engine by:
computing expected product profit whereby profit is computed using a customer's willingness to pay a certain price for the product, a customer's logistical data, product manufacturing cost, and production facility capacity;
computing a probability of demand that the product will result in a product sale using the expected product profit and the elasticity of demand by a customer for the product; and
input into memory business constraints selected from the group consisting of production capacity, production constraints and shipping constraints and the feasible resource allocation solutions and generate a profit optimal resource allocation solutions for the product based on the business constraints and the feasible resource allocation solutions and computing maximum expected product profit wherein maximum expected profit comprise expected product profit times the probability of demand that the product will result in a sale using an optimal capacity resource allocation solution engine running on the processor coupled to the resource solution generator.

2. The computer system apparatus of claim 1 further comprising a report generation engine configured to produce a profit optimal resource allocation solution report for the profit optimal resource allocation solution.

3. The computer system of claim 1 wherein the data preprocessing engine is configured to reduce the feasible resource allocation solutions to a smaller set based on the product manufacturing cost, the production facility capacity and the customer's logistical data.

4. The computer system of claim 2 wherein the report generation engine generates an opportunity report comprising recommended profit optimal resource allocation solutions for the product organized by a cost difference between a recommended solution and the incumbent capacity allocation solutions.

5. The computer system of claim 1 wherein the production facility capacity is selected from the group consisting of primary and backup production facilities.

6. The computer system of claim 5 wherein the resource solution generator uses the backup production facilities to compute the feasible profit optimal resource allocation solutions for the product.

7. The computer system of claim 1 wherein the configuration parameters for the production resources are selected from the group consisting of the production facility capacity, production facility capability, freight capacity, and machine capacity within a production facility.

8. The computer system of claim 6 wherein the computer processor further comprises a backup production facility allocation engine that computes optimal feasible resource allocation solutions using the backup production facilities.

9. The computer system of claim 1 wherein the computer processor further comprises a probability calculation engine that is programmed to generate:
a total manufacturing cost of the product;
a total freight cost for the product;
a total backup production facility cost;
a price of the product and an elasticity of demand for the product; and
a total profitability for the product using the total manufacturing cost of the product, the total freight cost for the product, the total backup facility cost and the price of the product using the elasticity of demand for the product.

10. The computer system of claim 1 wherein the supply and demand data for the product is selected from the group consisting of: production cost, transportation cost, production facility capability and production facility capacity.

11. The computer system of claim 1 wherein the resource solution generator and the optimal capacity resource allocation solution engine uses the profit optimal resource allocation solution to produce a solution that specifies additional capability to be added to a production facility that results in increased profit using the profit optimal resource allocation solution.

12. The computer system of claim 5 wherein the resource solution generator generates feasible backup production facilities ordered by optimal profit for the product.

13. The computer system of claim 1 wherein the computer processor further comprises running computer program instructions for a cost-to-serve engine that selects the profit optimal resource allocation solution based on a customer requirement to make the product in a production facility selected by the customer.

14. A computer implemented method, executing on a server computer with a computer processor coupled to a memory, for maximizing expected product profit for a product by identifying optimal allocations of production resources comprising:
inputting into memory a distribution of prices across a customer base for the product;
inputting into memory elasticity of demand for defined market segments across the customer base for the product;
inputting into memory the probability of demand for the product converting into a sale;
reading configuration parameters for production resources by the server computer;
receiving, by the server computer, supply and demand data for the product;
using an algorithm running in a data preparation engine running on the server computer combining, the distribution of prices for the product, the elasticity of demand for the defined market segments, the probability of demand for the product converting into the sale, the configuration parameters, and the supply and demand data and output a preprocessed dataset;
receiving and combining, by the server computer, the preprocessed dataset and incumbent capacity allocation solutions that represents a previous optimal allocation of the production resources for the product into a combined dataset;
receiving, by the server computer, the combined dataset and computing feasible resource allocation solutions for the product for a specified time period by
computing expected product profit whereby profit is computed using a customer's willingness to pay a certain price for the product, a customer's logistical data, product manufacturing cost, and production facility capacity;
computing a probability of demand that the product will result in a product sale using the expected product profit and the elasticity of demand by a customer for the product; and
receiving, by the server computer, business constraints and the feasible resource allocation solutions and generating profit optimal resource allocation solutions for each product that maximize expected product profit.

15. The computer implemented method as set forth in claim 14, wherein the server computer produces a profit optimal resource allocation solution report for the profit optimal resource allocation solutions.

16. The computer implemented method as set forth in claim 14, wherein the server computer reduces the feasible resource allocation solutions to a smaller set based on manufacturing cost, manufacturing capacity and logistical data.

17. The computer implemented method as set forth in claim 15 wherein the opportunity report comprises recommended profit optimal resource allocation solutions for the product organized by a cost difference between a recommended solution and the incumbent capacity allocation solutions.

18. The computer implemented method as set forth in claim 14 wherein the production resources comprise primary and backup production facilities.

19. The computer implemented method as set forth in claim 18 wherein the receiving the combined dataset and computing feasible resource allocation solutions for the product step uses the backup production facilities.

20. The computer implemented method as set forth in claim 14 wherein the configuration parameters for the production resources are selected from the group consisting of the production facility capacity, production facility capability, freight capacity, and machine capacity within a production facility.

21. The computer implemented method as set forth in claim 19 further comprising computing optimal feasible resource allocation solutions, by the server computer, using the backup production facilities.

22. The computer implemented method as set forth in claim 14 further comprising:
generating, by the server, a total manufacturing cost of the product;
generating, by the server, a total freight cost for the product;
generating, by the server, a total backup production facility cost;
generating, by the server, a price of the product and an elasticity of demand for the product; and
generating, by the server, a total profitability for the product using the total manufacturing cost of the product, the total freight cost for the product, the total backup facility cost and the price of the product using the elasticity of demand for the product.

23. The computer implemented method as set forth in claim 14 wherein the supply and demand data for the product is selected from the group consisting of: production cost, transportation cost, production facility capability and production facility capacity.

24. The computer implemented method as set forth in claim 14 further comprising producing a solution, by the server, that specifies additional capability to be added to a production facility that results in increased profit using the profit optimal resource allocation solution.

25. The computer implemented method as set forth in claim 18 further comprising ordering, by the server, feasible backup production facilities by optimal profit for the product.

26. The computer implemented method as set forth in claim 14 further comprising producing, by the server the profit optimal resource allocation solution based on a customer requirement to make the product in a production facility selected by the customer.

27. A computer program product for maximizing product profit by identifying optimal allocations of production resources, the computer program product comprising:
a non-transitory computer readable storage medium having computer usable code embodies herewith, the computer usable program code comprising:
computer usable program code configured to:
input into memory a distribution of prices across a customer base for the product, wherein the distribution of prices for the product is computed using a price optimization engine;
input into memory elasticity of demand for defined market segments across the customer base for the product wherein the elasticity of demand for the defined market segments is computed using the price optimization engine;
input into memory the probability of demand for the product converting into a sale;
input into memory configuration parameters for production resources using a configuration parameter engine running on the processor;
input into memory supply and demand data for the product from a computer store using a supply and demand engine running on the processor;
use an algorithm running in a data preparation engine running on the processor to combine the distribution of prices for the product, the elasticity of demand for the defined market segments, the probability of demand for the product converting into the sale, the configuration parameters with the supply and demand data and output a preprocessed dataset;
input into memory one or more incumbent capacity allocation solutions for the product that represents a previous optimal allocation of the production resources for the product;
receive and combine the preprocessed dataset and the incumbent capacity allocation solutions for the product into a combined candidate allocation solution dataset using a data preprocessing engine running on the processor;
receive the combined candidate allocation solution dataset and compute feasible resource allocation solutions for the product for a specified time period using a resource solution generator running on the processor coupled to the data preprocessing engine by:
computing expected product profit whereby profit is computed using a customer's willingness to pay a certain price for the product, a customer's logistical data, product manufacturing cost, and production facility capacity;
computing a probability of demand that the product will result in a product sale using the expected product profit and the elasticity of demand by a customer for the product; and
input into memory business constraints selected from the group consisting of production capacity, production constraints and shipping constraints and the feasible resource allocation solutions and generate a profit optimal resource allocation solutions for the product based on the business constraints and the feasible resource allocation solutions and computing maximum expected product profit wherein maximum expected profit comprise expected product profit time the probability of demand that the product will result in a sale using an optimal capacity resource allocation solution engine running on the processor coupled to the resource solution generator.
